(19) United States
(12) Patent Application Publication
(10) Pub. No.: US 2025/0284582 A1
(43) Pub. Date: Sep. 11, 2025

(54) SYSTEM AND METHOD FOR AUTOMATED IDENTIFICATION AND ASSISTED REPAIR OF CAN-RELATED FAULTS ACROSS MULTIPLE VEHICLE ECUS

(71) Applicant: Innova Electronics Corporation, Irvine, CA (US)

(72) Inventors: Keith ANDREASEN, Garden Grove, CA (US); Thuan Cong HUYNH, Ho Chi Minh City (VN); Ly BACH, Ho Chi Minh City (VN); Phuong PHAM, Fountain Valley, CA (US); Vo Thi Hong NHI, Ho Chi Minh City (VN)

(21) Appl. No.: 19/216,930

(22) Filed: May 23, 2025

Related U.S. Application Data
(63) Continuation-in-part of application No. 17/847,946, filed on Jun. 23, 2022.

(51) Int. Cl. G06F 11/07

(52) U.S. Cl. CPC G06F 11/0793; G06F 11/0739

(57) ABSTRACT

A diagnostic system and method for identifying and resolving vehicle Controller Area Network (CAN) bus faults is disclosed. The system connects to a vehicle's data link connector (DLC) and automatically retrieves diagnostic trouble codes (DTCs) from multiple electronic control units (ECUs). It filters the DTCs to identify those related to CAN communication errors, groups repeated DTCs across ECUs to highlight systemic faults, and assigns repair priority based on status, scope, and criticality. A user interface displays prioritized DTCs with definitions, affected systems, possible causes, and repair guidance. Upon technician input, the system re-scans the network to confirm resolution and updates the display accordingly. The invention supports semantic and conceptual recognition of communication faults, enabling robust, language-agnostic analysis. This system reduces diagnostic time, improves repair accuracy, and supports multilingual or manufacturer-specific DTC definitions without requiring external infrastructure or advanced user expertise.

### CROSS-REFERENCE TO RELATED APPLICATIONS

This application is a continuation-in-part to U.S. patent application Ser. No. 17/847,946, filed on Jun. 23, 2022, the contents of which are incorporated herein by reference in their entirety.

### STATEMENT RE: FEDERALLY SPONSORED RESEARCH/DEVELOPMENT

Not Applicable

### BACKGROUND

### Technical Field

The present disclosure relates generally to diagnostic systems for vehicles. The present disclosure relates more particularly to a system and method for detecting, filtering, grouping, and prioritizing Controller Area Network (CAN) Bus-related diagnostic trouble codes (DTCs) across multiple electronic control units (ECUs), and for guiding technicians through an efficient, step-by-step repair process based on the ranked severity of communication faults.

### Description of the Related Art

As a result of increased air pollution in large cities, many vehicles have utilized on-board computers to facilitate operation of electrical emission control devices since the early 1980s. However, as vehicle manufacturers have been required to comply with new emission and fuel efficiency standards, customers have also developed a desire for advanced technological features. As such, the on-board computer has evolved to accommodate these advancements.

For instance, many current on-board computer control systems are capable of providing control over many different vehicle functions and systems, such as the transmission, anti-lock brakes, electronic skid control, climate control, air bags, electric power steering, tire pressure monitoring, automatic headlights controls, keyless entry, telematics, body controls and suspension systems. Many current on-board computers include diagnostic programs to monitor input sensors, switches, actuators and facilitate communication between on-board electrical systems. Since vehicle operating conditions may quickly change, the on-board computers may continuously monitor, adjust or makes corrections with the goal of maintaining system operation within acceptable operational ranges.

Due to the increased responsibilities of the on-board computers, it became apparent that traditional hard-wired electrical systems were too heavy, bulky and expensive. Consequently, on-board computer networks were adopted, with the computer networks being capable of passing data back and forth between each other. The enhanced capabilities of on-board computer networks allowed for additional control functionalities, such as operation of exterior and interior lighting, door locks, power windows, heating and air conditioning, etc.

The on-board computers included in the computer networks are typically located throughout the vehicle, such as behind the dashboard, under the passenger's seat or the driver's seat, behind the knee and kick panels, and or at other locations that may be difficult to access. Wherever these computers are located, they may be connected to each other in some fundamental network layout and communication protocols. The incorporation of computer networks into the vehicle typically resulted in a reduction of wires, thereby reducing the complexity of the wiring commonly required to share data between the on-board computers and the vehicle's sensors and actuators. However, the interconnectedness of the computer networks resulted in an emphasis on the need for networks to remain healthy and capable of passing mission-critical data between vehicle systems. Accordingly, the diagnosis of the physical and data link layers of network communication is typically performed with expensive and complicated oscilloscopes or OEM-level scan tools. Attempting to diagnose network communication faults may be dependent on all ECUs (e.g., on board computers) being capable of detecting an issue and recording a fault code prior to being rendered unable to communicate.

While on-board computer networks vary from vehicle to vehicle, many on-board computer networks diagnose themselves in similar manners. For instance, each on-board computer may be assigned a DTC set related to network DTCs, and each on-board computer may monitor communications that may occur over the network. The on-board computer may share these DTCs with querying scan tools requesting network health information. The retrieved DTCs may be displayed for the operator, although network diagnostic solutions are typically not provided. In fact, many of these tools require the user to have in-depth technical knowledge to sort through the DTCs, service information and diagnostic troubleshooting charts to arrive at a diagnostic solution. As noted above, the ability to sort through such information typically requires the end-user to be well-versed in the use the scan tool.

Therefore, there is a need in the art to be able to determine a vehicle onboard computer's operational state by interrogating, querying, parsing and classifying on-board computer network DTCs. By performing predefined programmatic calculations based off the retrieved data, a reasonable and logical diagnostic strategy and fault origin may be identified. Thus, the need for an end-user possessing vehicle on-board network fault diagnostic expertise may be vastly reduced. Furthermore, the need for multiple scan tools capable of providing level of OEM network diagnostics may be lessened. Various aspects of the present disclosure address this particular need, as will be discussed in more detail below.

The CAN bus was first developed in the early 1980s as a response to the growing complexity of electronic systems in automobiles. At the time, vehicle wiring harnesses had become excessively bulky and unreliable due to the increasing number of point-to-point electrical connections required for engine control, safety systems, and emerging convenience features. There was a need for a robust, cost-effective communication protocol that would allow multiple ECUs to share data over a single two-wire bus, thereby reducing physical wiring and improving system modularity. The CAN protocol was introduced to the automotive industry in 1986 and later standardized in 1993 under ISO 11898. Its key advantages included a differential signal format for noise immunity, prioritized message arbitration, real-time transmission, and a built-in error handling and correction system.

The first production vehicle to implement a CAN bus was the 1991 Mercedes-Benz S-Class. Throughout the 1990s, European manufacturers led the adoption of CAN technology, integrating it into powertrain systems, anti-lock braking systems (ABS), and engine control modules (ECMs). Simultaneously, the rise of On-Board Diagnostics II (OBD-II) in the U.S., mandated in all cars and light trucks starting with the 1996 model year, further promoted the widespread use of digital communication protocols, with CAN rapidly becoming the standard transport layer. By the early 2000s, virtually all major automotive OEMs had adopted CAN for internal module communication, implementing multiple CAN buses within the same vehicle, often separating high-speed (500 kbps) networks for powertrain and chassis systems from low-speed (125-250 kbps) networks used for body control and infotainment.

As vehicle architectures became more advanced, CAN networks were supplemented by gateway modules to allow cross-network communication between functionally distinct domains. However, increased data demands from safety-critical systems like electronic stability control (ESC), adaptive cruise control, and early driver assistance technologies pushed the limits of traditional CAN. In response, Bosch introduced CAN FD (Flexible Data Rate) in 2012. CAN FD retained backward compatibility with classical CAN while increasing data payload size from 8 bytes to 64 bytes and enabling higher transmission rates during data phases, allowing more complex systems to coexist on the same bus without bottlenecks. CAN FD became increasingly common in vehicles manufactured from 2016 onward, especially in architectures involving active safety, over-the-air updates, and advanced diagnostics.

Today, nearly every modern vehicle includes several CAN buses and often incorporates multiple network types, such as CAN FD, LIN (Local Interconnect Network), FlexRay, and automotive Ethernet. However, CAN remains the most widely deployed in-vehicle communication protocol due to its simplicity, reliability, and widespread tool and component support. CAN buses facilitate not only real-time vehicle control but also serve as the backbone of diagnostic infrastructure. As vehicles continue to evolve into software-defined platforms, the role of the CAN bus remains critical, not only for real-time module coordination but also for fault detection, remote diagnostics, firmware updates, and cybersecurity monitoring. Ongoing efforts aim to improve CAN's integration with cloud-based systems, battery management units, and autonomous vehicle frameworks, ensuring that this nearly 40-year-old protocol continues to serve the ever-changing needs of the modern automotive landscape.

While prior diagnostic strategies may facilitate DTC collection and presentation, these solutions are limited in their ability to interpret the broader significance of network-related DTCs, particularly those associated with the vehicle's CAN bus itself. As a result, technicians are frequently presented with a large and disorganized list of DTCs across multiple systems, many of which may relate to the same underlying communication fault. In such scenarios, the technician must manually determine which DTCs are redundant, which are the most critical to address, and which may be safely ignored or deferred, often without clear guidance from the tool itself. This process is time-consuming, error-prone, and heavily reliant on technician expertise, especially when multiple ECUs report overlapping or cascading communication faults.

Furthermore, as modern vehicles incorporate dozens of ECUs across multiple CAN sub-networks (e.g., powertrain, chassis, body), identifying the true scope and priority of CAN-related faults becomes even more difficult. A single CAN-related communication error may trigger DTCs in multiple modules, but conventional scan tools do not provide insight into the relative severity, origin, or system-level impact of the fault. Nor do they typically highlight repeated DTCs across different ECUs or offer guidance on whether a fault is likely systemic or isolated.

The CAN bus serves as the central nervous system of modern vehicles, enabling dozens of ECUs to communicate and coordinate functions across powertrain, chassis, body, infotainment, and safety systems. When faults occur within the CAN bus, whether due to physical wiring damage, signal degradation, electrical interference, or module failure, the consequences can be widespread and often difficult to trace. A single disrupted signal may prevent multiple ECUs from sharing critical data, leading to the loss of control over interconnected subsystems. For example, if the anti-lock braking system (ABS) cannot communicate with the engine control module (ECM), stability control functions may be compromised, especially during emergency braking or cornering, posing a direct risk to vehicle occupants.

CAN bus faults can also disable or interfere with safety-critical components such as airbags, electronic power steering, lane-keeping systems, and adaptive cruise control. In some cases, the fault may not completely disable the system but may introduce latency or intermittent behavior that is difficult to reproduce, conditions that erode driver confidence and vehicle reliability. From a service perspective, CAN-related issues are among the most complex and time-consuming to diagnose because they often manifest as multiple simultaneous DTCs across unrelated systems. Without advanced diagnostic tools or technician expertise, service personnel may mistakenly replace functioning ECUs or wiring harnesses in an attempt to isolate the issue, resulting in unnecessary costs that can range into the thousands of dollars.

Furthermore, misdiagnosis of a CAN bus fault can result in repeat visits, poor customer satisfaction, and in fleet or commercial vehicles, prolonged downtime and operational losses. For electric and hybrid vehicles, where precise coordination between power electronics, thermal systems, and battery management units (BMUs) is critical, a CAN fault may prevent safe vehicle startup, interrupt charging processes, or trigger limp mode operation. In autonomous and semi-autonomous vehicles, where continuous data exchange between perception, decision-making, and control modules is essential, a CAN bus disruption may cause an immediate system handoff or total disengagement, posing an unacceptable risk in active traffic.

In summary, CAN bus failures introduce a high degree of diagnostic uncertainty, system interdependency risk, and cost exposure. The result is not only inefficient service and elevated costs, but also reduced vehicle safety, reliability, and customer trust.

### BRIEF SUMMARY

In accordance with one embodiment of the present disclosure, there is provided a vehicle diagnostic method based on an analysis of communication signals on a vehicle having a plurality of ECUs. The vehicle diagnostic method includes transmitting an ECU status request signal to the vehicle and receiving a status response signal from the vehicle. The status response signal includes a plurality of ECUs on the vehicle that are responsive to the transmitted ECU status request signal. A state of health report is generated and includes a comprehensive listing of all ECUs associated with the vehicle. Each ECU in the state of health report responsive to the transmitted ECU status request signal is associated with an active status, while the remaining ECUs in the state of health report being associated with an inactive status. The method additionally includes receiving communication DTCs from the vehicle, with each communication DTC being associated with at least one ECU. Identifying a primary probable cause ECU as being one of the ECUs associated a received communication DTC that is also associated with an inactive status.

The method may additionally include receiving historical DTCs from the vehicle. A secondary probable may be determined based on an analysis of the historical DTCs.

The method may additionally include generating the state of health report includes organizing all of the ECUs according to associated communication networks on the vehicle. The associated communication networks may include a powertrain network, a body network, a chassis network, and a multi-media network.

The step of receiving communication DTCs may include receiving a message error DTC, a time-out DTC and a bus-off DTC. The step of identifying a primary probable cause may include identifying a communication network or an ECU associated with a highest number of received communication DTCs.

The method may include receiving non-communication DTCs and filtering the received communication DTCs from the non-communication DTCs.

The method may also comprise requesting data associated with the probable cause.

According to another embodiment, there is provided a handheld automotive diagnostic device comprising a memory circuit having computer executable instructions stored thereon, which when executed, cause the diagnostic device to: send a status request signal to a vehicle network including a plurality of on-board computers and having a known communication architecture; receive a response signal from the vehicle network, the response signal including response information from active ones of the plurality of on-board computers; identify inactive ones of the plurality of on-board computers by comparing the active ones of the plurality of on-board computers to a comprehensive listing of the plurality of on-board computers; classify each of the plurality of on-board computers into one of a plurality of network groups, the plurality of network groups being arranged on the vehicle network to at least partially define the known communication architecture; receive fault codes from the plurality of on-board computers; categorize a network status of each fault code as being either a network type fault code or a non-network type fault code based on an origin of the fault code; and identify a probable cause based on an assessment of the network status, and the known communication architecture.

According to another embodiment, there is provided a vehicle diagnostic method based on an analysis of communication signals on a vehicle having a plurality of ECUs. The vehicle diagnostic method includes transmitting an ECU status request signal to the vehicle and receiving a status response signal from the vehicle. The status response signal includes a first group of ECUs on the vehicle that have responded to the transmitted ECU status request signal. The method additionally includes receiving communication DTCs from the vehicle, with the communication DTCs being associated with a second group of ECUs. A primary probable cause ECU is identified by comparing the second group of ECUs to the first group of ECUs, the primary probable cause ECU being included in the second group of ECUs and not in the first group of ECUs.

The method may additionally include the steps of receiving historical DTCs from the vehicle, and determining a secondary probable cause based on an analysis of the historical DTCs.

A handheld diagnostic device is designed to detect and resolve communication issues on a vehicle's Controller Area Network (CAN) bus. The device includes a processor, memory, a display-based user interface, and a communication interface configured to connect to the vehicle's diagnostic link connector (DLC) and communicate with multiple onboard control modules (ECUs). The apparatus retrieves diagnostic trouble codes (DTCs) over the CAN bus and identifies which codes relate specifically to communication faults by filtering out unrelated ones. It groups CAN-related DTCs that appear across different ECUs into fault clusters, assigns a repair priority to each group based on scope, severity, and affected systems, and displays this prioritized information with definitions, causes, and repair suggestions.

The method implemented by the device includes connecting to the vehicle, polling ECUs for DTCs, filtering for CAN-specific faults, grouping repeated errors into systemic issues, calculating fault priority, and displaying repair guidance. The user can interact with the system to confirm repairs, after which the tool re-scans the network to determine whether faults have been resolved and updates the display accordingly.

Software stored on a non-transitory computer-readable medium enables all core operations, including DTC retrieval, filtering, grouping, and prioritization. The software uses matching logic that recognizes both standardized and manufacturer-specific terminology, including synonyms and conceptually equivalent fault descriptors, even across different languages. It may also access remote databases to retrieve updated DTC definitions or fault patterns. Feedback from technician input, including confirmed repairs or deferred actions, may be logged for adaptive learning or future diagnostic refinement. All operations are executed locally on the device, with no dependency on external computing systems.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic diagram of an exemplary communication network overlaid on a top view of a vehicle;

FIG. 2 is an electrical schematic of a communication network on the vehicle;

FIG. 3 is a chart depicting an exemplary Powertrain portion of the state-of-health;

FIG. 4 is a chart depicting an exemplary Body portion of the state-of-health;

FIG. 5 is a chart depicting an exemplary Chassis portion of the state-of-health;

FIG. 6 is a chart depicting an exemplary Multimedia portion of the state-of-health;

FIG. 7 is a chart depicting an exemplary received Message Error DTC;

FIG. 8 is a chart depicting exemplary received Time-Out DTCs;

FIG. 9 is a chart depicting exemplary received Bus-Off DTCs;

FIG. 10 is single chart combining all of the DTCs shown in FIGS. 7-9 to illustrate how a primary probable cause may be determined;

FIG. 11 shows information leading to a component primary cause of the ECM;

FIG. 12 shows information leading to a network primary cause of the Powertrain network;

FIG. 13 is an exemplary chart, which shows possible secondary probable causes of the Powertrain network, an open/short power/ground, charging system, battery and/or ignition;

FIG. 14 is an exemplary flowchart associated with one embodiment of a vehicle diagnostic method based on analyzing communication signals on a vehicle network.

Common reference numerals are used throughout the drawings and the detailed description to indicate the same elements;

FIG. 15 is an example embodiment of a system for automated identification and assisted repair of CAN-related faults across multiple vehicle ECUs;

FIG. 16 is a flowchart of an example embodiment of a system for automated identification and assisted repair of CAN-related faults across multiple vehicle ECUs;

FIG. 17 illustrates an example embodiment of network discovery and ECU polling for automatic DTC retrieval;

FIG. 18 illustrates an example embodiment of CAN bus DTC filtering;

FIG. 19 is a table illustrating example DTC U-codes, along with a likely cause and suggested solutions;

FIG. 20 is a table illustrating example, manufacturer-specific CAN-bus DTCs, along with a likely cause and suggest solution;

FIG. 21 is a table illustrating examples of additional CAN bus information that is obtainable from a DLC port, along with an associated diagnostic value and example use case;

FIG. 22 is illustrates an example table of bus error types derived from a combination of automotive industry standards, manufacturer diagnostic practices, and engineering-level technical documentation;

FIG. 23 illustrates examples of several key error conditions that may occur on a CAN and provides a technical interpretation of each condition, along with likely causes and recommended solutions; and

FIG. 24 illustrates an example table of common ECUs in modern vehicles.

### DETAILED DESCRIPTION

The detailed description set forth below in connection with the appended drawings is intended as a description of certain embodiments of a vehicle diagnostic system and method and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure generally relate to the analysis of communication signals on the various vehicle communication networks included on a vehicle under test to try and identify a possible cause of an issue on the vehicle. In this regard, diagnostic data received from the vehicle may be analyzed in the context of the known electrical architecture of the vehicle to try and pinpoint where a root fault or problem may be occurring. When data is received from the vehicle, the data may reflect several different issues, such as network level faults, component level faults, time-out errors, etc. In some instances, there may be interaction between various systems or components, and thus, if one component or system has an issue, there may be a trickle-down effect on the downstream components or systems. In this regard, otherwise healthy components or systems may be associated with error codes or messages due to issues occurring in upstream or related components/systems.

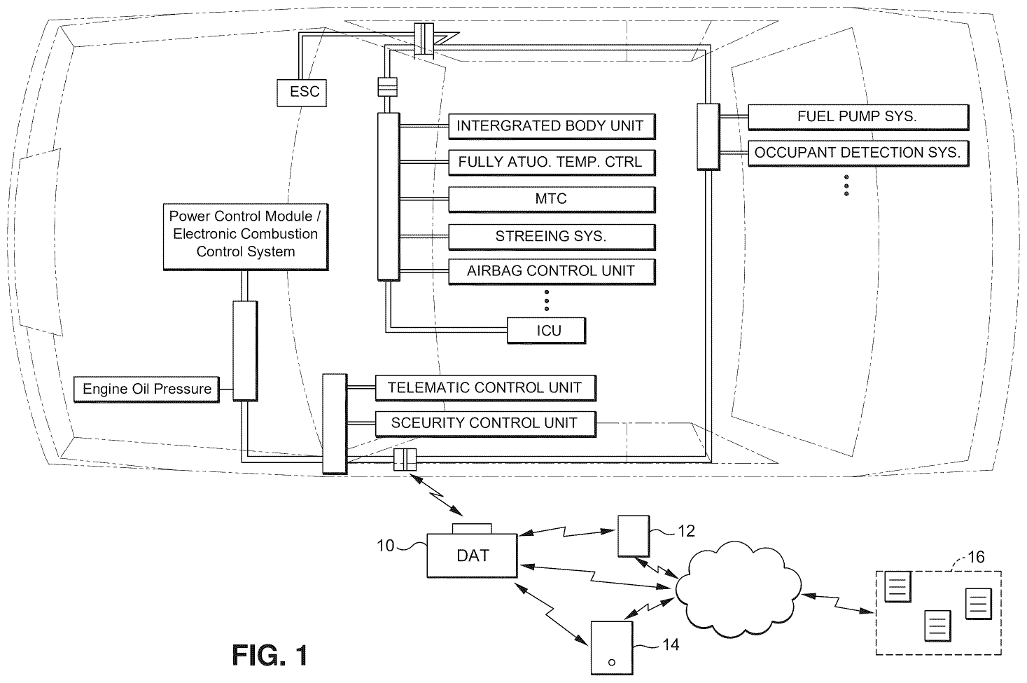

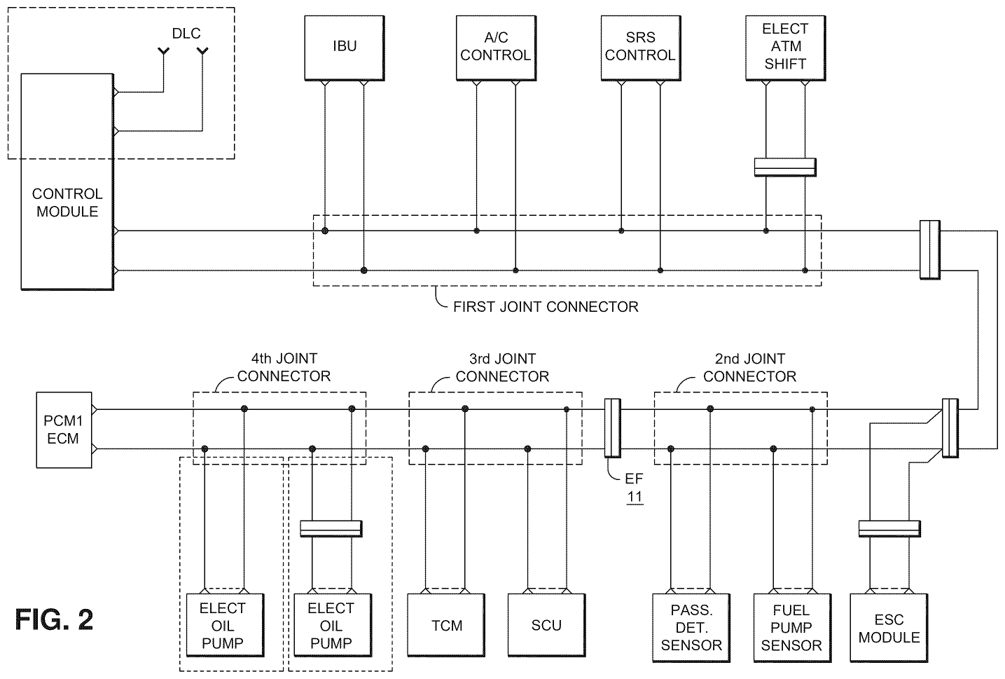

Referring now to FIGS. 1 and 2, there is depicted example views of a P-CAN (Powertrain Controller Area Network) for a vehicle. In this regard, it is understood that a given vehicle communication network may include several sub-networks, including the Powertrain network, Body network, Chassis network, and Multimedia network, among others. It is understood that various vehicles may have different network groups, and that the scope of the present disclosure is not limited to any specific number or type of network groups. FIGS. 1 and 2 show the exemplary P-CAN network simply to illustrate a general layout or architecture of various electrical components in a given P-CAN network, and are not intended to be a thorough depiction of a P-CAN network. The layout of the exemplary P-CAN network is such that the IBU, A/C Control Module, SRS Control Module, and Electronic ATM Shift Lever are all connected via a common first joint connector. The Fuel Pump Control Module and Passenger Occupant Detection Sensor are connected via a common second joint connector. The TCM and SCU are connected via a common third joint connector, and a pair of Electronic Oil Pumps are connected via common fourth joint connector. The first, second, third, and fourth joint connectors are arranged in series with each other, with the data link connector (DLC) (e.g., the diagnostic port) being upstream of the first joint connector. Thus, any communication between the data link connector and the second, third, and fourth joint connectors must pass through the first joint connector. Accordingly, if there is a problem with the first connector, the entire P-CAN module may generate faults or be non-responsive. However, the issue may simply relate to the first joint connector. If the first joint connector is fixed, and the system is tested again, all faults may go away. Similarly, if the received diagnostic data shows there are issues with the TCM, SCU, and the Electronic Oil Pumps, then the shared hardware may be the location of the root problem. In this instance, the root problem may relate to EF11 or the third joint connector.

According to various aspects of the present disclosure, the method entails requesting diagnostic data from a vehicle network using a data acquisition and transfer device (DAT) 10. The DAT 10 may refer to any device capable of communicating with a vehicle network, either directly or indirectly (e.g., such as through a diagnostic port). The DAT 10 may include, but is not limited to a scan tool, a code reader, a dongle, a handheld communication device, or other hardware known by those skilled in the art. The DAT 10 may include a connector port (e.g., an OBD-2 connector port) that is configured to be operatively connectable, through wired or wireless communication, to a corresponding communication port on the vehicle. The DAT 10 may additionally include a processor and a memory with computer executable instructions stored thereon, that when executed by the processor facilitate the various functionalities described herein. For more information regarding the DAT 10, please refer to U.S. Pat. No. 9,824,507, entitled MOBILE DEVICE BASED VEHICLE DIAGNOSTIC SYSTEM, and U.S. Pat. No. 11,158,141, entitled SYSTEM AND METHD FOR PROACTIVE VEHICLE DIAGNOSIS AND OPERATIONAL ALERT, both of which are owned by Innova Electronics Corp., the assignee of the present disclosure, and the contents of which are expressly incorporated herein by reference. Furthermore, examples of a DAT 10 include, but are not limited to, the 5510 CarScan Tech, the 7111 Smart Diagnostic System-OBD2 Tablet, and the 1000 CarScan Mobile, all sold by Innova Electronics Corp.

An ECU status request signal may be generated by the DAT 10 and transmitted to the vehicle network via the diagnostic port on the vehicle once the DAT 10 is operatively connected to the vehicle. The ECU status request signal may include instructions or commands executable by the vehicle to collect information regarding the status of active or responsive on-board computers (e.g., ECUs) included in the vehicle network. Subsequently, a status response signal may be received by the DAT 10 from the vehicle network, with the response signal including response information from active on-board computers. The on-board computers included in the status response signal may be referred to as a first group of on-board computers In this regard, any on-board computer that may be inactive for any reason may send no response signal due to their inactive status.

The data received from the vehicle may be used to compile, derive, or construct a network state-of-health, which may identify all on-board computers as having either an active status or an inactive status. The active computers may be identified using the response signal received from the vehicle. The inactive computers may be identified using a comprehensive list of all on-board computers associated with the vehicle under test and comparing that list with a list of active computers. The comprehensive list may be obtained using vehicle identification information (e.g., year, make, model, engine; vehicle identification number; etc.) that may be retrieved from the vehicle, such as an electronic vehicle identification number (VIN), acquired by the user, such as scanning a barcode on the vehicle associated with the vehicle's VIN or taking a picture of the VIN or license plate which may be used to derive vehicle identification information. It is also contemplated that the vehicle identification information may be entered by the user into a user interface on the DAT 10 or via a kiosk 12 associated with the DAT 10 or via a smartphone or other handheld communication device 14 in communication with the DAT 10 or one or more remote servers 16 having access to software and/or data needed to implement the functionalities described herein. For more information regarding the use of a kiosk 12 or handheld communication device 14 in connection with a vehicle diagnostic process, please refer to U.S. Patent Application Publication No. 2021/0279978 entitled KIOSK BASED VEHICLE DIAGNOSTIC SYSTEM, owned by Innova Electronics Corporation, the contents of which are expressly incorporated herein by reference. The vehicle identification information may be used to access a database having comprehensive lists sorted by vehicle identification information to identify the comprehensive list associated with the vehicle under test. In this regard, the database may be located on the DAT 10, on a handheld communication device in communication with the DAT 10, or on a remote server in communication with the DAT 10. It is also contemplated that the vehicle may supply the comprehensive list.

Those on-board computers that are on the comprehensive list, but not on the list of active computers may be considered the inactive on-board computers. Properties, such as function and location of each on-board computer may be known, and thus, both the active and inactive computers may be sorted into their respective network groups in a state-of-health report. The state-of-health report may serve as a reference point for subsequent data queries.

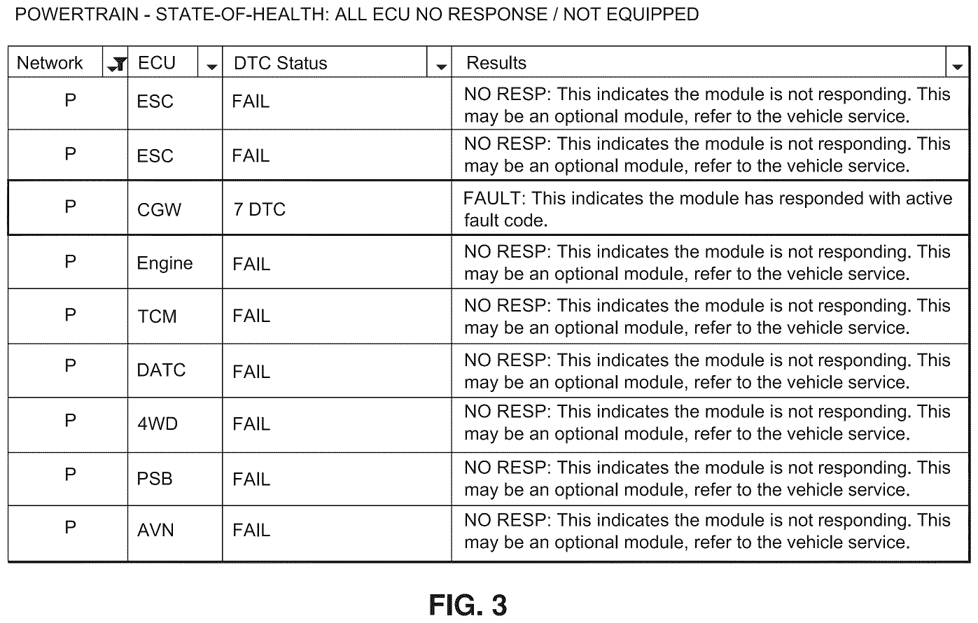

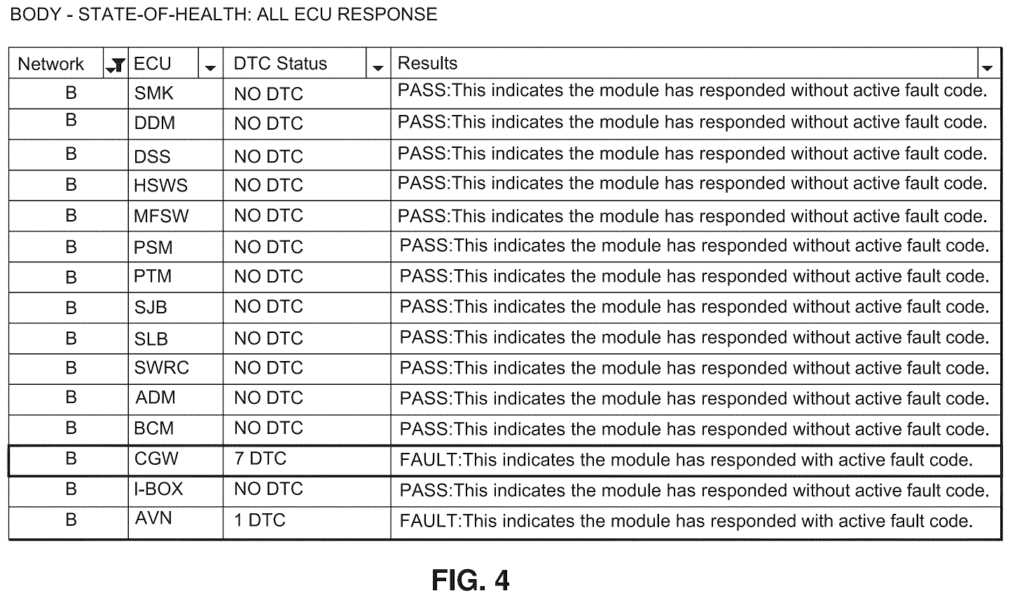

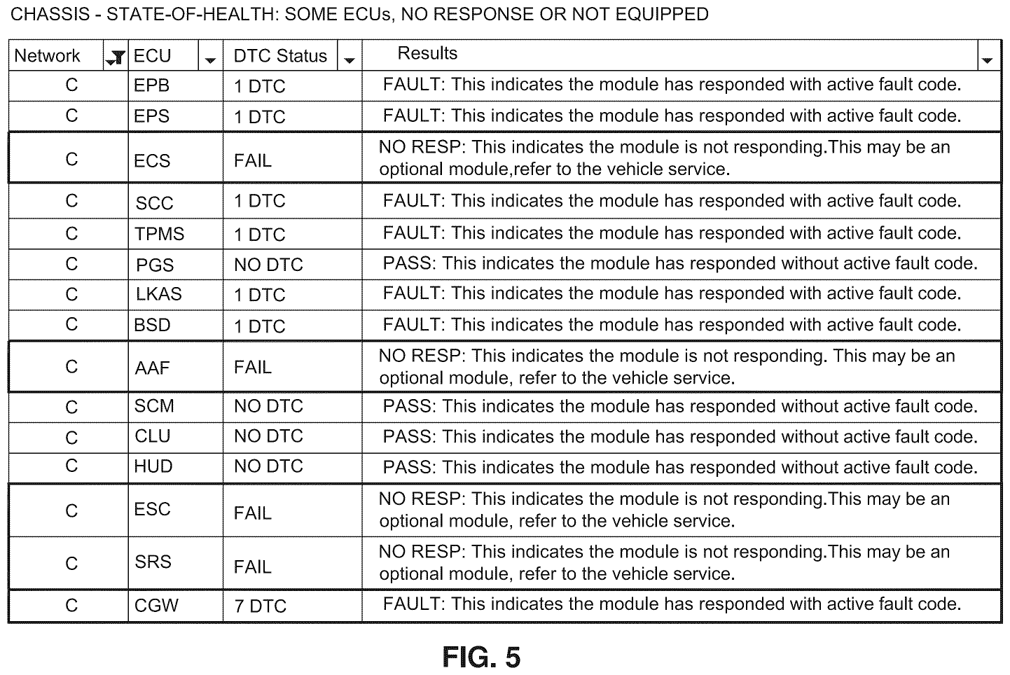

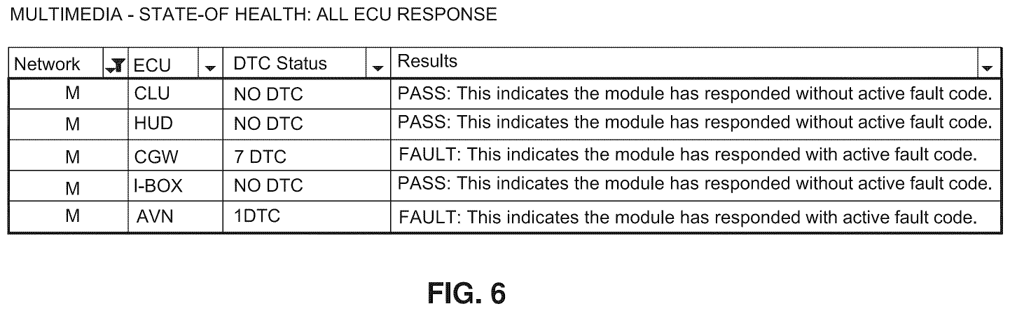

FIGS. 3-6 depict exemplary state-of-health sub-reports organized by network groups. In particular, FIG. 3 shows a Powertrain portion of the state-of-health, FIG. 4 shows a Body portion of the state-of-health, FIG. 5 shows a Chassis portion of the state-of-health, and FIG. 6 shows a Multimedia portion of the state-of-health. The state-of-health of each network group may range from all ECU's not responding or not being equipped (See Powertrain—FIG. 3), to all ECU responding (See Body—FIG. 4 and Multimedia—FIG. 6), to some ECUs responding, while others not responding (See Chassis—FIG. 5).

Looking in more detail again at FIG. 3, the Powertrain portion of the state-of-health shows that all of the various ECUs associated with the Powertrain network show no response, except for the CGW (i.e., central gateway) ECU. Note that the CGW may not be unique to the Powertrain network, and thus, faults associated therewith (e.g., 7 DTCs) may not be associated with the Powertrain network, whereas, the remaining ECUs listed in the Powertrain state-of-health may be unique to the Powertrain network, and their failure to respond may be indicative of a problem with the Powertrain network, as will be discussed in more detail below.

Looking in more detail now at FIG. 4, the Body portion of the state-of-health shows that all of the ECUs unique to the Body network provided a response, and thus, are active. The CGW ECU appears again in the same manner as the Powertrain portion of the state-of-health, due to the CGW also being associated with the Body network. The AVN ECU reports 1 DTC, while all other ECUs report no DTCs.

Looking in more detail now at FIG. 5, the Chassis portion of the state-of-health shows that some of the ECUs unique to the Chassis network provided a response, and thus, are active, while other ECUs unique to the Chassis network did not provide a response, and thus are inactive or not equipped on the vehicle under test. In this regard, the database including the listing of ECUs associated the vehicle under test used to compile the state-of-health may include ECUs that may not be equipped on the vehicle under test. For instance, some vehicles of the same year and make may include a different grouping of ECUs on a particular network, i.e., a first vehicle may include a first group of ECUs on a particular network, while a second vehicle may include a second group of ECUs on that particular network. There may be significant overlap with the first and second group of ECUs (e.g., in some cases only differing by one or two ECUs), however, the comprehensive listing included in the state of health includes each ECU included in both the first group and the second group. It is contemplated that the comprehensive listing of ECUs may be compiled from any number of ECU groups (e.g., more than two) without departing from the spirit and scope of the present disclosure.

The Chassis ECUs that responded include a combination of some ECUs with no reported DTCs, while other ECUs responded with 1 DTC. The CGW ECU appears again in the same manner as the Powertrain portion of the state-of-health, due to the CGW also being associated with the Chassis network.

Looking in more detail now at FIG. 6, the Multimedia portion of the state-of-health shows that all of the ECUs unique to the Multimedia network provided a response, and thus, are active. The CGW ECU appears again in the same manner as the Powertrain portion of the state-of-health, due to the CGW also being associated with the Multimedia network. The AVN ECU reports 1 DTC, with the AVN ECU also appearing on the Powertrain and Body state of health reports. As you will note, the AVN ECU on the Powertrain portion of the state-of-health reflects a fail status, while the AVN on the Body and Multimedia portions of the state-of-health reflects a received DTC. This discrepancy may be the result of the Powertrain network being down, and thus, ECUs along that network may not be communicating. However, the Body, Chassis and Multimedia networks may remain operational, and thus, the AVN ECU may communicate on those networks.

Once the state-of-health report is generated, fault codes may be retrieved from the vehicle using the DAT 10. The received fault codes may be sorted or categorized based on the origin (e.g., location) of each fault code as well as the time when each fault code was triggered. With regard to origin, each fault code may be categorized as being either a network type fault code or a non-network type fault code. With regard to timing, each fault code may be classified as being either active, pending, or historical. For purposes of further analysis in the diagnostic method and system disclosed herein, it is the active network type fault codes that may be of particular interest, and thus, those fault codes may be filtered or separated from the rest. Moreover, the active fault codes may be further classified or categorized into one of the following groups: Message Error, Time-Out, or Bus-Off. Each received active fault code may be associated with an on-board computer, with the group of on-board computers associated with the received active fault codes being referred to as a second group of on-board computers.

The Message Error group may include fault codes recorded when one ECU receives a response from another ECU, with the data in the received response being invalid or corrupt. The Time-Out group may include fault codes recorded when an ECU did not receive a response from another ECU. The Bus-Off group may include fault codes that have been recorded when an ECU no longer can maintain communication and stops sending and receiving messages.

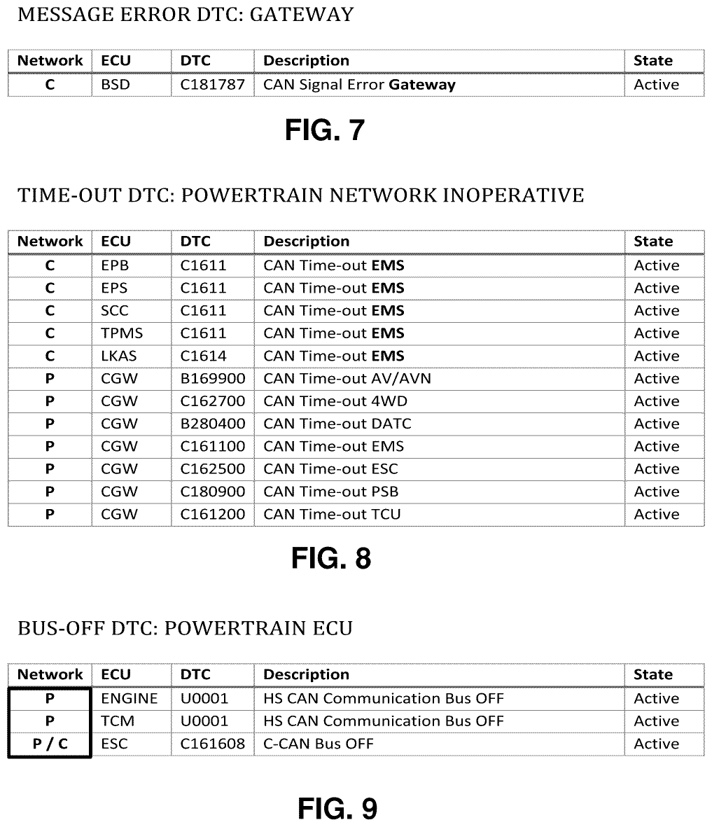

FIG. 7 shows an example of a received Message Error DTC, which was generated by the BSD ECU associated with the Chassis Network. In particular, the received DTC is associated with a CAN signal error, and more specifically, that a message from the CGW ECU includes corrupt or invalid data, indicative of a problem.

FIG. 8 is an exemplary chart including received Time-Out DTCs. As can be seen, the DTCs within the chart are each associated with an ECU from which the DTCs are generated. The chart depicted in FIG. 8 groups the ECUs based on their associated network. The first five rows of the chart include ECUs included in the Chassis network, while the remaining rows in the chart include ECUs included in the Powertrain network. All of the DTCs generated by Chassis ECUs all refer to a CAN Time-Out with communication with the EMS (Engine Management System). The DTCs associated with the Powertrain network were all generated by the CGW ECU and relate to CAN Time-out with various ECUs included in the Powertrain network, e.g., AVN/PGS, 4WD, DATC, EMS, ESC, PSB, and TCU. In this regard, the ECUs are indicative of the CGW having not received a signal from the aforementioned ECUs.

After having received the DTCs associated with the Powertrain network, the Powertrain state-of-health may be referenced review the DTC status for those Powertrain ECUs. This comparison reveals that all of the Powertrain ECUs that received Time-Out DTCs were also listed in the State of Health as being non-responsive. Thus, it can be concluded that these ECUs are indeed located on the vehicle based on those ECUs being associated with specific Time-Out DTCs received by the DAT. However, each of those DTCs is associated with one or more underlying issues. Given that many of the Powertrain ECUs were associated with a Time-Out DTC, it is indicative of a possible problem associated with the Powertrain network being inoperative.

FIG. 9 is an exemplary chart of Bus-Off DTCs that have been received from the ECUs listed in the second column, i.e., the Engine ECU, TCM ECU and ESC ECU. Bus-Off DTCs may refer to an ECU unable to communicate on internal or external CAN lines for a prescribed period of time (e.g., two seconds), which triggers the DTC. In the example depicted in FIG. 9, all of the ECUs that generated a Bus-Off DTC are associated with the Powertrain network, with the ESC ECU also being associated with the Chassis network.

According to one embodiment, a primary probable cause may be found by using an algorithm that queries probability based off frequency of faults, the number of faults, and the types of faults. The active DTCs may be initially evaluated and then historical DTCs may be evaluated. The historical DTCs may be associated with a “secondary” probable cause, which may be used to place higher probability on the primary probable cause results.

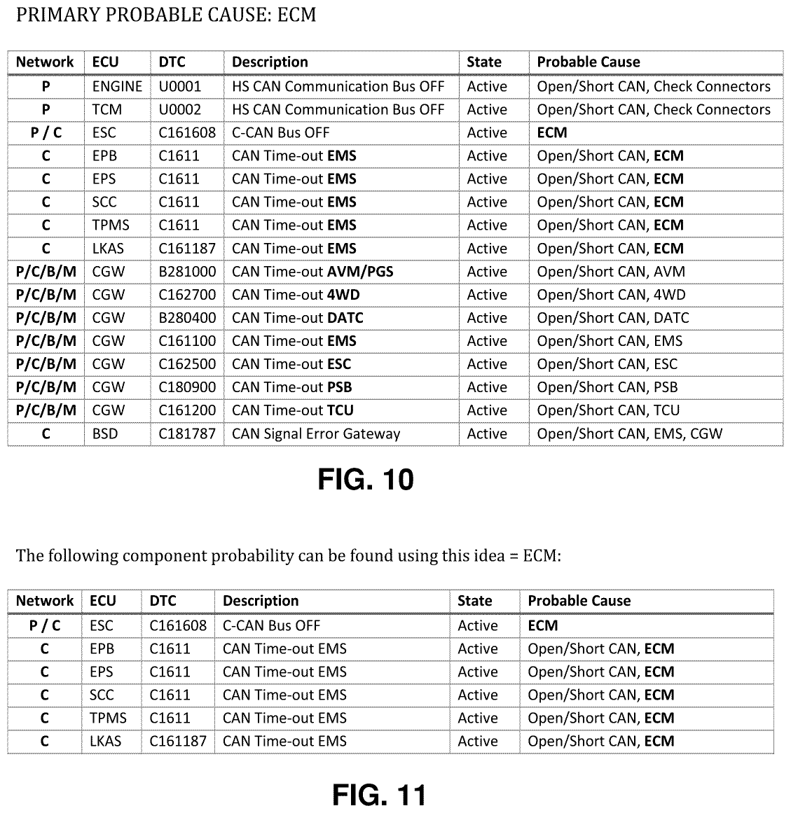

FIG. 10 is single chart combining all of the DTCs shown in FIGS. 7-9 to illustrate how a primary probable cause may be determined. The chart in FIG. 10 not only includes a comprehensive listing of all of the DTCs from FIGS. 7-9, but also includes a column on the right which lists a probable cause for each ECU. The most common probable cause listed in FIG. 10 is the ECM, and thus, because it is the probable cause that appears the most (e.g., it is associated with more DTCs than any other probable cause), it may be identified as the primary probable cause.

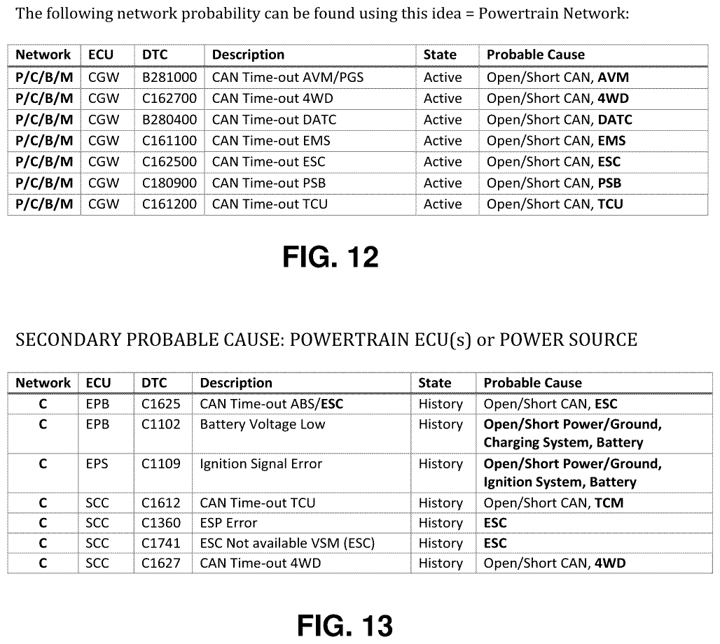

It is contemplated that the primary probable cause may be categorized by a component and/or a network. FIG. 11 shows information leading to a component primary cause of the ECM. All of the information in FIG. 11 is taken from FIG. 10, and is based on the ECM being the highest frequency component listed in the probable cause column of FIG. 10. FIG. 12 shows information leading to a network primary cause of the Powertrain network. In this regard, the information in FIG. 12 is derived from FIG. 10 and illustrates that the Powertrain network is associated with the highest number of faults.

The secondary probable cause may be found using an algorithm that queries probability based off frequency of faults, the number of faults, and the types of faults. Identifying a secondary probable cause may strengthen the primary probable cause. Consequently, historical DTC results or secondary probable causes may enhance or strengthen the probability of the primary probable cause results.

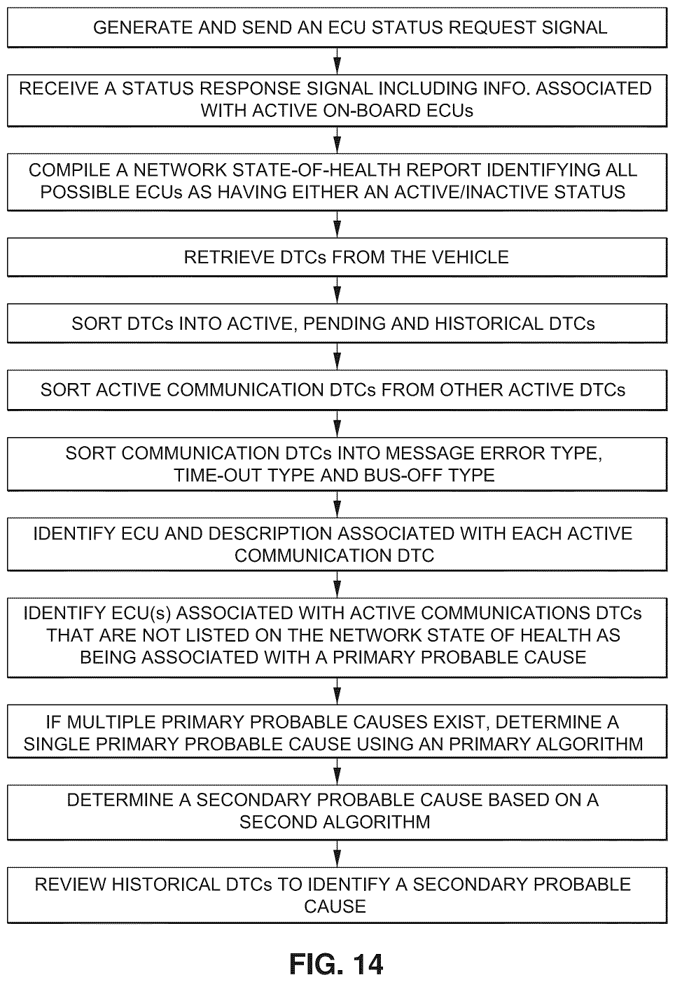

FIG. 13 is an exemplary chart, which shows possible secondary probable causes of the Powertrain network, an open/short power/ground, charging system, battery and/or ignition. FIG. 14 is an exemplary flowchart associated with one embodiment of a vehicle diagnostic method based on analyzing communication signals on a vehicle network.

Therefore, in summary, the state-of-health query reports: P-CAN is down—no ECU responded with CGW ECU responding with 7 DTCs. B-CAN is operational—all ECUs responded with CGW ECU responding with 7 DTCs. C-CAN is operational—15 ECUs' responded, 3 down or NOT equipped, CGW with 7 DTCs. M-CAN is operational—all ECUs responded. CAN DTC message query and parsing algorithm applied, the probable cause is either the ECM is defective, and/or, the power source to the Powertrain Network is dead.

In addition to the features and diagnostic methods described above, further embodiments enhance technician usability, diagnostic precision, and repair efficiency, particularly in connection with issues arising from the CAN Bus system. While previous embodiments provided a powerful framework for identifying inactive ECUs and correlating communication faults based on ECU responsiveness and network grouping, certain diagnostic scenarios require additional resolution support beyond fault localization alone.

The present disclosure teaches a system and method for generating and displaying a diagnostic interface that interprets CAN-related DTC data in a meaningful, technician-friendly format. The system automatically filters for network-related DTCs, organizes them by fault definition and reporting module, and ranks them in order of likely repair priority. In doing so, the system presents a clear, actionable repair sequence that reduces reliance on technician expertise, supports faster resolution of systemic communication issues, and offers an intuitive diagnostic workflow that is compatible with existing vehicle architectures and scan tool hardware.

Specifically, technicians working in real-world environments often benefit from more granular insights into the nature of CAN bus-related DTCs, including contextual data, repair suggestions, and interpretive assistance to guide decision-making. Accordingly, additional embodiments extend the foundational system by introducing a targeted diagnostic workflow designed to isolate, interpret, and triage CAN bus DTCs with greater clarity and technician-facing utility. These embodiments introduce methods, system components, and user interface elements that may operate in conjunction with or in parallel to the previously described diagnostic routines. In particular, these embodiments incorporate DTC filtering logic, interpretive layers based on DTC definitions, and the presentation of possible causes and suggested repairs for each identified CAN-related fault. Furthermore, enhancements to the display logic enable the grouping and highlighting of repeated DTCs across multiple systems, allowing technicians to more easily assess fault propagation and prioritize repairs.

These extensions maintain compatibility with the communication architecture and ECU responsiveness framework detailed above, while offering an expanded feature set tailored to the dynamic and technician-centric environment of modern vehicle servicing.

In modern vehicles, the CAN bus enables communication between a wide array of ECUs, which collectively govern various vehicle subsystems including the powertrain, chassis, body electronics, and infotainment. The onboard diagnostic system continuously monitors this communication and, when irregularities are detected, generate DTCs to assist with fault identification.

Among the various types of DTCs, U-codes are specifically reserved for network communication faults. These codes indicate a failure in the expected exchange of data between ECUs and are essential for diagnosing issues within the vehicle's communication infrastructure. Unlike P-codes (Powertrain), B-codes (Body), or C-codes (Chassis), which are generally tied to component-level failures, U-codes identify loss of communication, invalid data, or network configuration inconsistencies.

For example, DTC U0100 signifies “Lost Communication with ECM/PCM ‘A’” and indicates that one or more ECUs expected to receive data from the engine or powertrain control module but did not. Similarly, U0121 denotes “Lost Communication with the ABS Control Module,” pointing to a communication fault with the vehicle's braking system controller. Other U-codes may indicate broader network-level failures, such as U0001, which refers to the high-speed CAN communication bus as a whole.

These codes are typically triggered when a transmitting ECU fails to send a message, or when a receiving ECU fails to acknowledge receipt within a predefined time window. Physical issues such as open circuits, shorted CAN lines, faulty connectors, or failing modules may all contribute to such communication faults. Some U-codes may also reflect software mismatches, particularly within modular networks where firmware compatibility is critical.

As such, U-codes form a foundational element for the subject communication-based diagnostic process, particularly when isolating faults related to the CAN bus. Their interpretation is valuable for narrowing down a root cause of system malfunctions and for informing a technician as to whether the issue lies in the wiring, the module, or network behavior itself. The diagnostic process disclosed in example embodiments is designed, in part, to intelligently identify, filter, and interpret such U-codes, and other CAN bus related information available via a vehicle DLC port to assist technicians in prioritizing and resolving CAN bus-related faults.

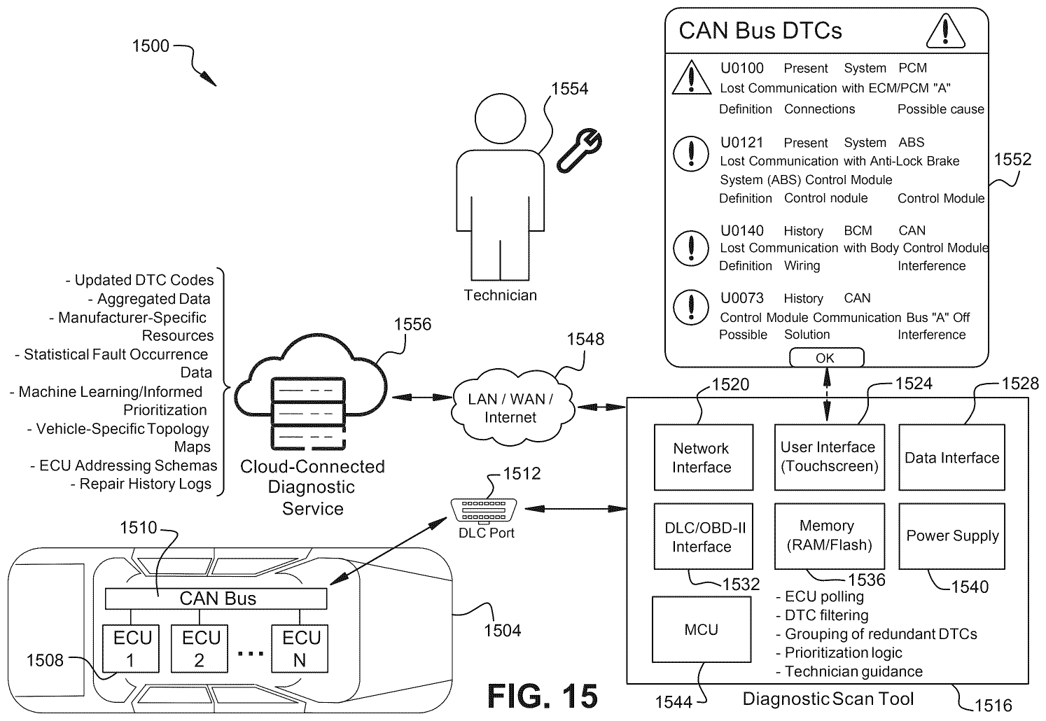

FIG. 15 illustrates a diagram 1500 of an example embodiment of a system for automated identification and assisted repair of CAN-related faults across multiple vehicle ECUs. Vehicle 1504 has multiple ECUs, such as ECU 1508, in data communication by at least one CAN bus, such as CAN bus 1510. Vehicle 1504 has a DLC port 1512 configured to be coupled in data communication with diagnostic scan tool 1516. Scan tool 1516 includes network interface 1520, user interface 1524, suitably comprised of a touchscreen, data interface 1528, such as a Bluetooth or NFC interface, DLC/OBD-II interface 1532, memory 1536, power supply 1540 and microcontroller unit (MCU) 1544. Scan tool 1516 is configured to communicate with DLC port 1512 via DLC/OBD-II interface 1532.

In certain embodiments, the apparatus includes a communication interface that comprises both a physical connector configured to mate with the vehicle's DLC and one or more CAN transceivers capable of bi-directional data exchange with the vehicle's CAN bus. The CAN transceiver is suitably configured to support multiple CAN channels, permitting simultaneous communication across distinct CAN domains such as powertrain, chassis, or body control networks. In some implementations, the communication interface suitably includes logic for monitoring low-level CAN bus conditions, such as bus-off states, message timeouts, acknowledgement errors, and arbitration loss events. These conditions may be logged by the apparatus and used to assist in identifying degraded communication performance, network instability, or module isolation on the CAN bus. The interface may also support active polling of ECUs and passive listening modes, enabling the device to capture both solicited responses and unsolicited messages transmitted by the vehicle's ECUs.

Network interface 1520 is configured for data communication with network cloud 1548, suitably comprised of a local area network (LAN), a wide-area network (WAN), which may comprise the Internet, or any suitable combination thereof. Network cloud is comprised of any suitable wired or wireless transmission medium, or any suitable combination thereof.

Scan tool 1516 functions as an advanced diagnostic interface that connects to a vehicle's onboard network via DLC port 1512 to automatically scan and communicate with all accessible ECUs. It retrieves DTCs from the ECUs, filters and isolates those related to the CAN bus, and identifies duplicate codes that appear across multiple systems. The tool then groups and organizes these DTCs by definition and reporting module, analyzes their status (active, stored, pending), and assigns a repair priority based on severity, system criticality, and fault propagation. The scan tool presents these prioritized results to the technician through display screen 1552 generated with user interface 1504. The display screen shows results of a CAN bus scan, suitably followed by suggested repair actions and possible root causes, for use by technician 1554. Optionally, the tool communicates with a cloud server, such as cloud server 1556 via network cloud 1548, to retrieve information such as updated DTC definitions, statistical fault patterns, vehicle-specific CAN layouts, and service bulletins, further enhancing diagnostic accuracy and reducing repair time. After repairs are performed, the scan tool supports re-scanning and validation to confirm fault resolution and guide next steps.

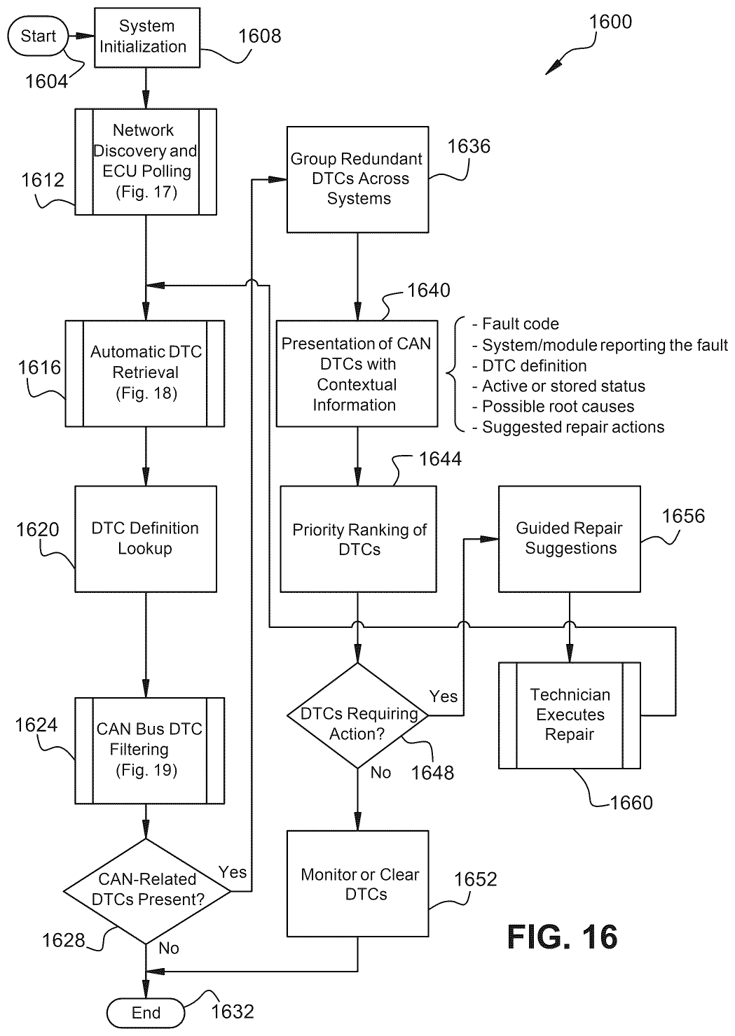

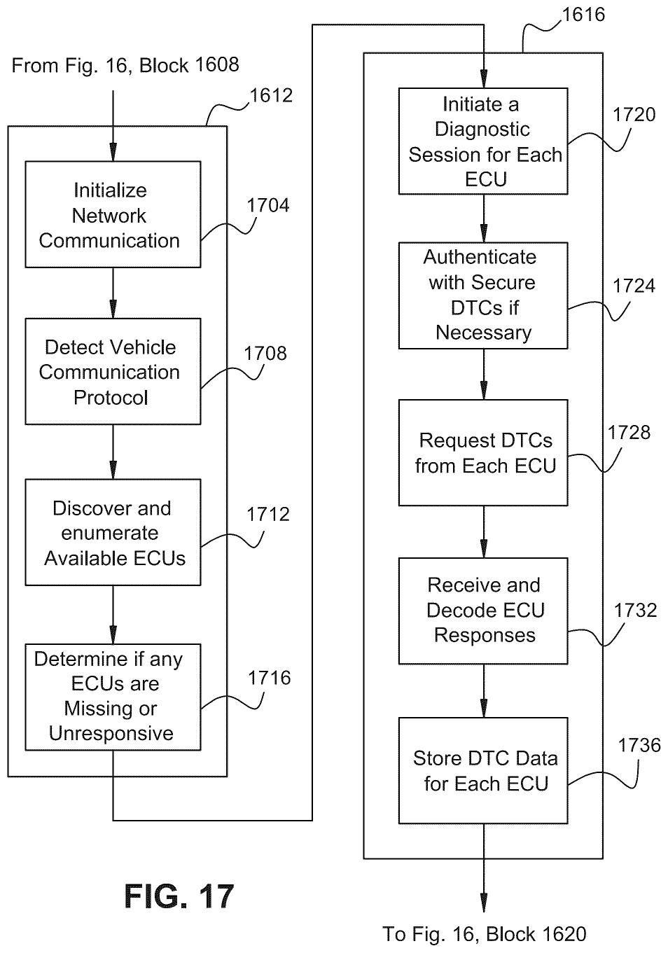

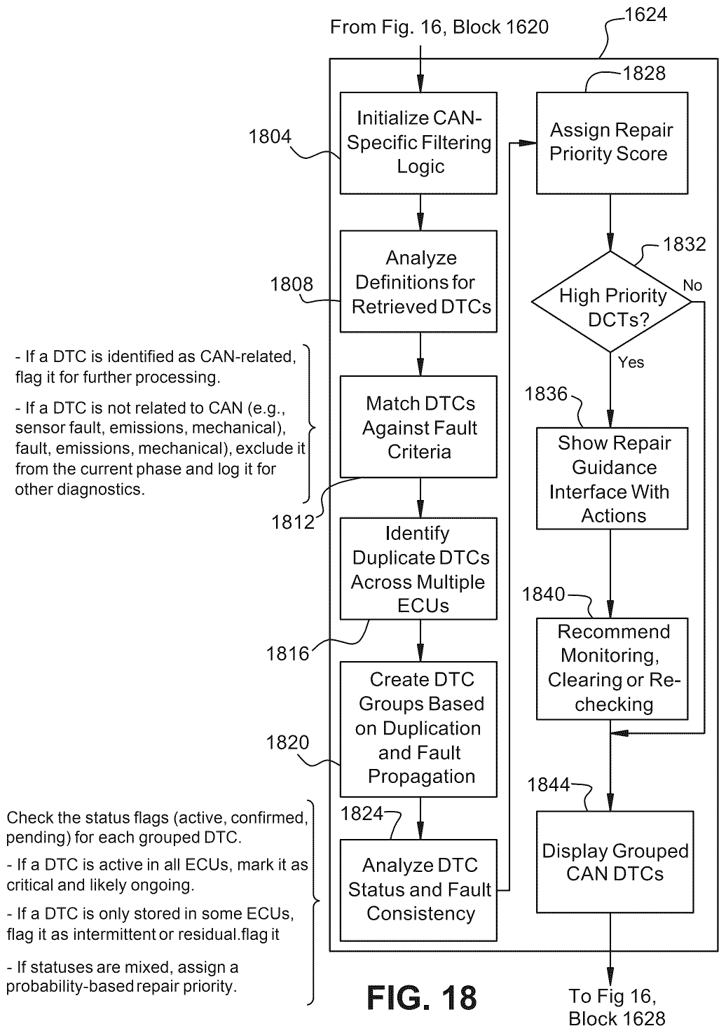

FIG. 16 is a flowchart 1600 of a system for automated identification and assisted repair of CAN-related faults across multiple vehicle ECUs. The system commences at block 1604 and proceeds to block 1608 for system initialization. The diagnostic device is powered on and connected to the vehicle's DLC. Upon connection, it identifies the vehicle make, model, year, and supported communication protocols (e.g., CAN, CAN-FD, etc.).

Next, network discovery and ECU polling is completed at block 1612. The device performs a system-wide scan to identify all ECUs present on the vehicle. It sends broadcast messages and listens for responses from each ECU on all available networks. A detailed description of network discovery and ECU polling follows below with FIG. 17. Next, DTCs are retrieved at block 1616. The system requests and retrieves all available DTCs from each responding ECU. This includes both active (current) and historical (stored) fault codes. A detailed description of automatic DTC retrieval follows below with FIG. 18.

Next, a lookup is made for definitions associated with retrieved DTCs at block 1620. Retrieved DTCs are cross-referenced with a database to obtain the standardized or manufacturer-specific definition of the code. Additional metadata, such as affected subsystem, severity, and known symptom patterns, is also gathered. Such lookup may be done locally on the device, or in conjunction with information supplied from a cloud server.

Next, CAN bus DTC filtering is completed at block 1624: The system evaluates each DTC to determine whether it is related to the CAN bus. This is suitably accomplished by analyzing the DTC's code type (e.g., U-codes). In certain embodiments, the diagnostic system filters DTCs by analyzing their associated definitions or descriptions for the presence of one or more keywords, phrases, or equivalent terms that are indicative of communication-related faults on the vehicle's CAN bus. The filtering process may include direct string matching, keyword scanning, or semantic analysis using natural language processing (NLP) techniques or pre-defined keyword libraries.

The system may look for terms such as “communication,” “timeout,” “bus-off,” “invalid data,” “no response,” “link failure,” “network error,” or similar expressions commonly associated with CAN bus errors. These terms may be found in standardized DTC definitions (e.g., U-codes per SAE J2012) or in proprietary, manufacturer-specific diagnostic records, which may be written in various natural languages.

In some implementations, the keyword filtering process supports multilingual environments by translating DTC definitions or using a language-agnostic model trained to recognize conceptually or semantically equivalent fault indicators, regardless of the source language or terminology used.

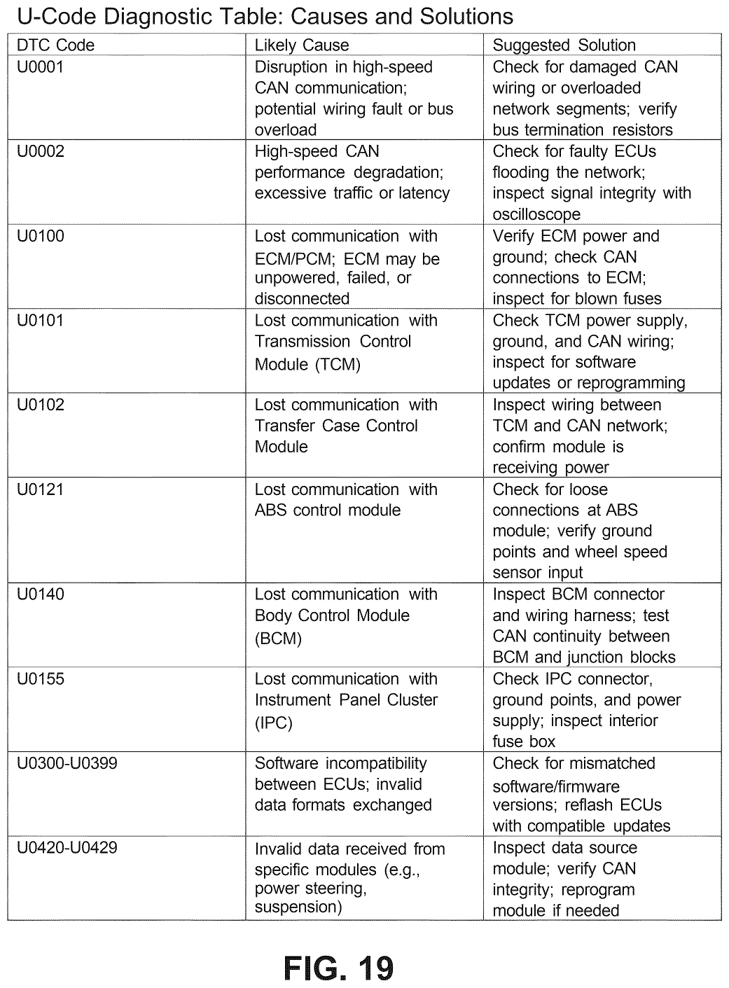

The filtering mechanism may include a matching threshold or weighting system to account for partial matches, synonyms, or language variants, allowing for flexible identification of communication-related faults. This approach ensures robust identification of relevant DTCs, even when the terminology varies between manufacturers, regions, or diagnostic protocols. A detailed description of CAN bus DTC filtering follows below with FIG. 19.

Next a test for CAN-related DTCs is made at block 1628. If no CAN-related DTCs are present, the system exits the CAN diagnosis mode at block 1632 and may optionally suggest other diagnostic paths (e.g., powertrain, chassis, or emissions systems). If CAN-related DTCs are present, the system proceeds to block 1636 where redundant DTCs are grouped. The system searches for identical DTCs that appear across multiple ECUs. If duplicates are found (e.g., U0100 from PCM, TCM, and BCM), they are grouped and displayed together. This grouping provides insight into the scope and impact of the issue.

Next, CAN DTCs are presented, such as being shown to a technician, on a user interface display, at block 1640. Such presentation is suitably accompanied contextual information. When a DTC is retrieved from a vehicle's ECU, it typically includes a 5-character alphanumeric code (e.g., U0100) and a basic definition (e.g., “Lost Communication with ECM/PCM”). However, that alone is not always enough to make a confident diagnosis. DTC contextual information is the set of additional data points and interpretive metadata that provide meaningful context about the fault. This includes the status of the code (active, pending, confirmed, or stored), the specific ECU(s) that reported it, and the timestamp or mileage when the fault occurred. It may also include associated freeze frame data, which captures a snapshot of vehicle sensor values and operating conditions at the moment the fault was logged, such as vehicle speed, engine RPM, throttle position, battery voltage, or CAN bus voltage levels.

Contextual information also suitably includes the frequency and duration of the fault (e.g., intermittent vs. consistent), whether it occurred during a specific operating mode (e.g., ignition on, engine cranking, driving), and whether the same code was reported by multiple ECUs simultaneously. This helps determine if a fault is localized (e.g., a faulty sensor) or systemic (e.g., a CAN bus disruption). In more advanced systems, contextual info may further include manufacturer-specific DTC enhancements, known repair patterns, or historical repair outcomes associated with the same fault on similar vehicles, especially when cloud diagnostics are involved.

Filtered and grouped CAN DTCs are suitably presented to the technician with one or more of the following attributes:
Fault code
System/module reporting the fault
DTC definition
Active or stored status
Possible root causes
Suggested repair actions

Next, a priority ranking of DTCs is completed at block 1644: Each DTC is assigned a repair priority based on its type, severity, frequency, and system criticality. Active faults affecting multiple systems receive higher priority. This allows technicians to triage issues and begin work on the most critical faults first. Ranking is also suitably completed with additional information available from a vehicle OBD system, such as live data or freeze-frame data.

Next, a test is made at block 1648 as to whether any DTCs requiring action have been identified. If not, the system suitably recommends monitoring or clearing the faults without repair at block 1652 before the system ends at block 1632. If DTCs requiring action are present, the system proceeds to block 1656 where guided repair instructions are provided to the technician. For each high-priority DTC, the system offers suggested next steps, such as:
Inspect specific connectors or wires
Check power and ground supply to the affected ECU
Replace or reprogram a module
Perform signal integrity tests (voltage, resistance)

After the technician completes the suggested repair at block 1660, the system suitably returns to block 1616 for rescanning to determine if the repair was successful, or if any CAN-related DTCs are present. Once all critical faults are resolved or deferred, the system generates a final report. This suitably includes:
Original fault codes and status
Actions taken
Resolved vs. unresolved DTCs
Timestamped repair log for service documentation

Some use case examples follow.

### Guided CAN Bus Repair Examples Based on DTC Diagnostics

### Example 1: U0100—Lost Communication with ECM (Powertrain Control Module)

Scenario: The scan tool detects U0100 reported by the TCM Module, ABS Module, and Body Control Module (BCM). All report the code as active.

Interpretation & Prioritization: Grouped as a critical, multi-system CAN fault affecting the ECM. Highest priority assigned due to loss of powertrain communications.

### Guided Repair Steps

Check for ECM power and ground integrity.
Inspect ECM connector for corrosion, bent pins, or water intrusion.
Measure voltage on CAN-H and CAN-L at the ECM connector.
Confirm ECM is physically present on the CAN network using live ping or topology view.
If no signal is present from ECM, test continuity from ECM to DLC.
Replace ECM only if wiring and connector are confirmed good.

### Example 2: U1110—Lost Communication with ABS Module (Nissan)

Scenario: DTC U1110 appears in the Engine Control Module (ECM), Instrument Cluster, and Steering Control Module.

Interpretation & Prioritization: Repeated across critical safety systems. Prioritized as high due to impact on braking/stability systems.

### Guided Repair Steps

Verify ABS module has ignition and battery power.
Use multimeter or scan tool bus monitor to check for termination resistance (should be ˜60 ohms).
Measure CAN voltages at ABS connector.
Check connector pin tension and module grounds.
If ABS module is non-responsive on the bus but all voltages are normal, recommend module replacement or reprogramming.

### Example 3: U1900—-CAN Communication Bus Fault (Ford)

Scenario: The DTC U1900 is reported by five modules including BCM, GEM (Generic Electronic Module), and Power Steering.

Interpretation & Prioritization: Generic bus fault affecting multiple systems; active in several modules but passive in others.

### Guided Repair Steps

Use scan tool's bus monitor to check for message traffic and signal voltage waveforms.
Disconnect non-essential modules one at a time to isolate potential bus short or interference.
Inspect for aftermarket accessories (e.g., alarms, remote starters) tapping into the CAN lines.
Check fuse block and junction boxes for loose terminals or overheated connectors.
If interference stops after disconnecting a module, replace or reprogram that module.

### Example 4: U0420—Invalid Data Received from Power Steering Module

Scenario: This DTC is stored in the ABS module and ECM but not active.

Interpretation & Prioritization: Medium-priority fault, likely intermittent or historical. Still relevant due to its impact on ESC/traction systems.

### Guided Repair Steps

Confirm software version of power steering control module via cloud database.
Check for known TSB or recall related to calibration mismatch (e.g., U0300 series).
Inspect CAN wiring to power steering motor/control unit for signs of flex fatigue.
If confirmed up-to-date and wiring is intact, clear code and test drive to see if fault reoccurs.
Recommend flash update if data shows persistent mismatch with no hardware issue.

### Example 5: U0101—Lost Communication with TCM (Transmission Control Module)

Scenario: Reported by ECM and Instrument Cluster. ECM shows code as active, cluster as stored.

Interpretation & Prioritization: Ranked high due to drivability concerns and primary module involvement.

### Guided Repair Steps

Confirm TCM power (battery and ignition) and ground at module connector.
Inspect TCM for signs of thermal damage or fluid ingress.
Check CAN lines for corrosion, pinch points, or damage due to movement or rubbing.
Test CAN continuity from TCM to gateway or ECM.
If TCM is present on bus but unresponsive, perform reprogramming or software reload.

FIG. 17 illustrates blocks 1612, network discovery and ECU polling, and block 1616, automatic DTC retrieval, from FIG. 17, in detail. First, vehicle network communication is established at block 1704 where the diagnostic device is powered on and communication through the vehicle's DLC is established at block 1704. CAN transceivers are activated and prepared to interact with one or more CAN buses present in the vehicle. Next, an appropriate diagnostic communication protocol is detected, configured and activated at block 1708. This automatically detect the active communication protocol (e.g., ISO 15765-4 for CAN, ISO 14229 for UDS, or manufacturer-specific formats). The device is then configured for correct baud rate, addressing mode (physical/functional), and timing parameters.

Next, broadcast polling requests are sent to discover ECUs at block 1712. A global diagnostic session initiation requests (such as “Tester Present” or “Diagnostic Session Control”) is sent to all addresses on the CAN network, awaiting responses. Responsive ECUs are identified and registered. ECUs that respond, are tagged with a physical or functional address, role (e.g., ECM, TCM, ABS), and communication parameters are recorded. Next, at block 1716 a determination is made if any expected ECUs are missing: If all ECUs are accounted for, proceed to DTC retrieval. If one or more expected ECUs are missing, attempt re-polling and wait for delayed responses. If still unresponsive, log the ECU as inactive and flag for technician awareness. The process continues with scanning of available ECUs.

The system then progresses to block 1720 within block 1616. A diagnostic session is initiated for each identified ECU. Either a standard or extended session request is used depending on the protocol and ECU configuration.

Next, at block 1724 ECUs requiring access control, are initiated with a challenge-response handshake. If access is granted, the process continues. If access fails, the system retries or skips and logs it as restricted. Next, at block 1728, a DTC read command (e.g., UDS $19 02), is sent to each ECU, including any necessary filtering flags (e.g., active faults only, confirmed faults, or all stored DTCs). Each ECU response is received and decoded at block 1732. Incoming response messages are parsed at block 1736. DTCs, including their codes, status (active, pending, confirmed) are extracted, along with any linked freeze-frame data or subsystem identifiers. The system returns to block 1620 of FIG. 16.

FIG. 18 illustrates block 1624, CAN bus DTC filtering, of FIG. 16 in detail. Proceeding from block 1620 of FIG. 16, CAN-specific filtering logic is initialized at block 1804. The diagnostic system activates a software module configured to detect DTCs that are specific to communication faults within the CAN. This module references an internal or cloud-based library of known CAN-related DTCs, including standardized fault codes such as U0001 or U0100, and manufacturer-specific codes such as U1100 and U1900.

At block 1808, each DTC retrieved in the prior phase is analyzed for its definition and associated keywords. The system queries a DTC definition database and parses each entry for terms such as “communication,” “bus,” “timeout,” “lost,” or “invalid data.” This semantic analysis helps to identify fault codes that may indicate CAN-related issues, even if not strictly labeled as such.

At block 1812, the system compares each DTC against a predefined set of criteria to determine whether it qualifies as a CAN-related fault. If the DTC matches the criteria, it is flagged and passed into the CAN-specific diagnostic pathway. DTCs not related to CAN are excluded from further processing in this phase but may be logged for secondary analysis or technician awareness.

At block 1816, the system checks for repeated DTCs reported across multiple ECUs. If the same DTC identifier and definition (e.g., U0100—Lost Communication with ECM) appears in multiple modules such as the powertrain control module (PCM), transmission control module (TCM), and anti-lock braking system (ABS), the system flags this as a potentially systemic fault.

At block 1820, the system groups matching DTCs into shared fault clusters. Each group is associated with a list of affected ECUs and labeled by its shared fault definition. Grouping allows the technician to visualize fault propagation across the vehicle network and helps distinguish isolated module issues from broader network failures.

At block 1824, the system evaluates the fault status (e.g., active, confirmed, pending) of each DTC in the group. If the DTC is active in all modules, the system marks the group as critical and likely ongoing. If the DTC appears only as stored or pending in certain ECUs, it may be flagged as intermittent or residual. Mixed fault statuses trigger probability-weighted scoring.

At block 1828, a priority score is assigned to each DTC or DTC group. This score is calculated using a rules-based or weighted algorithm that considers whether the DTC is active, the number of ECUs reporting it, the safety or criticality level of affected systems (e.g., ABS or ECM), and any known fault patterns from manufacturer diagnostic libraries.

At block 1832, the system evaluates whether any DTCs have exceeded a predefined threshold for repair priority. If one or more high-priority faults are detected, the system proceeds to generate repair guidance at block 1836. If no such DTCs are present, the system may recommend clearing inactive faults or scheduling a follow-up check at block 1840. CAN groups are displayed at block 1844. The system then returns to block 1628 of FIG. 16,

FIG. 19 is a table illustrating example DTC U-codes, along with a likely cause and suggested solutions. The table of FIG. 19 provides a structured overview of several standardized U-codes used across the automotive industry to denote faults in the communication systems of modern vehicles, particularly those involving the CAN. These codes, which are part of the OBD-II diagnostic framework, are valuable in identifying and resolving issues related to lost communication, invalid data, and software incompatibility between ECUs.

The first entry, U0001, indicates a fault on the High-Speed CAN Communication Bus. This code suggests a general disruption in the vehicle's primary communication network. Likely causes include wiring faults, physical damage to CAN lines, or overload due to excessive message traffic. Technicians are advised to inspect the CAN wiring for damage, check network terminations, and use diagnostic tools to verify message traffic integrity.

U0002 is closely related but refers specifically to performance degradation on the high-speed CAN bus. This may not represent a complete failure but rather an issue with timing, message collisions, or latency that interferes with normal ECU communication. A common cause is a malfunctioning ECU that floods the bus with messages or introduces delays. Diagnostic procedures should include monitoring bus load, signal timing, and validating each module's message frequency.

The code U0100 represents lost communication with the ECM/PCM (Engine or Powertrain Control Module). This is a critical fault that often causes driveability problems or complete engine shutdown. Causes may include a failed ECM, damaged wiring, or power supply issues. Resolution steps typically include verifying the ECM's power and ground circuits, checking fuses, and ensuring uninterrupted CAN bus communication to and from the module.

U0101 flags lost communication with the TCM. In modern vehicles where transmission behavior is tightly integrated with other systems, loss of contact with the TCM can severely impact vehicle performance. Diagnosis involves inspecting the TCM's dedicated wiring, verifying CAN signal continuity, and ensuring proper TCM software configuration.

U0102 is triggered when the vehicle loses communication with the Transfer Case Control Module, a component found in all-wheel-drive or four-wheel-drive systems. Intermittent power, damaged connectors, or module failure can all contribute to this fault. Corrective action includes verifying the transfer case module's power supply and checking for corrosion or mechanical damage in the harness.

The code U0121 denotes lost communication with the ABS Control Module, which can compromise braking performance and disable vehicle stability systems. Possible causes include loose wiring, a failed ABS module, or broken CAN lines. A thorough inspection of sensor connectors, module ground points, and ABS fuses is usually required.

U0140 refers to lost communication with the BCM, a central component responsible for many non-drivetrain vehicle functions such as lighting, locks, and windows. A BCM fault may present as wide-ranging electrical issues. Diagnosis involves testing communication lines to the BCM, validating its power and ground inputs, and confirming that the module is active on the CAN network.

U0155 is associated with lost communication with the Instrument Panel Cluster (IPC). When this occurs, gauges, warning lights, and displays may become inoperative or behave erratically. This is often due to power supply failure to the IPC, a disconnected communication line, or internal failure of the cluster module itself.

The table also includes U0300-U0399, which are codes used to identify software incompatibility between modules. These faults occur when one ECU receives data from another that it cannot interpret, often due to mismatched firmware versions following repairs, updates, or ECU replacements. Diagnosis typically involves using OEM scan tools to compare software versions and performing a module reflash or configuration update to restore compatibility.

Lastly, U0420-U0429 refer to invalid data received from various ECUs. Each code in this range identifies a specific module as the source of the invalid data. These errors are often caused by software bugs, corrupted messages, or failing modules. Technicians must isolate the transmitting ECU, verify its software integrity, and confirm that it is properly integrated within the CAN architecture.

Overall, these U-codes serve as essential indicators of system-level communication failures within the vehicle. The causes and recommended solutions listed in the table allow for structured troubleshooting and faster resolution of complex electrical faults. Incorporating this diagnostic knowledge into automated scan tools, repair algorithms, or technician workflows, as described in the present invention, can greatly enhance efficiency, reduce guesswork, and improve accuracy in resolving CAN bus-related faults.

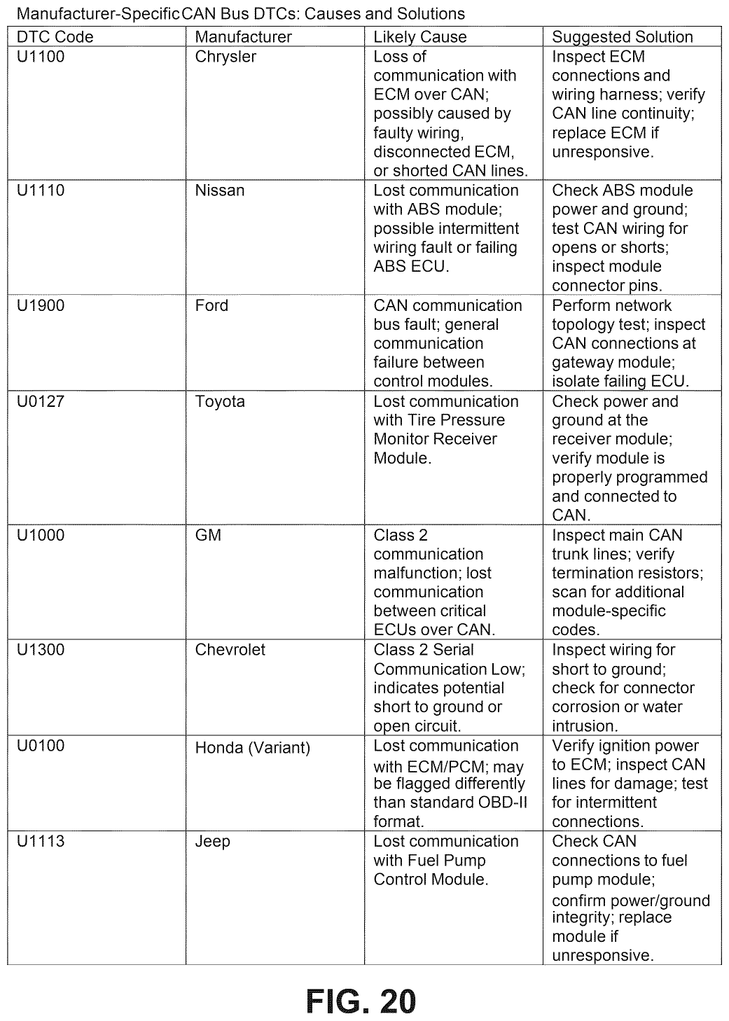

FIG. 20 is a table illustrating example, manufacturer-specific CAN-bus DTCs, along with a likely cause and suggest solution. The table lists a curated selection of DTCs that are not standardized under the general OBD-II (SAE J2012) framework but are instead defined by specific vehicle manufacturers. These codes, while following the familiar U-code format that typically designates network or communication errors, reflect proprietary design implementations, module configurations, and error-handling logic unique to each OEM. Each of these manufacturer-specific codes evidences a fault in the CAN or a related communication system and provides insight into how communication between vehicle systems may be impaired.

For example, U1100 as used by Chrysler indicates a loss of communication with the ECM. This may be caused by a disconnected ECM, a failure in the CAN wiring harness, or an internal fault in the ECM's transceiver. In these cases, resolution involves verifying the ECM's power and ground connections, inspecting the CAN lines for continuity or shorts, and replacing the ECM if no external faults are found.

Similarly, U1110 in Nissan vehicles signals lost communication with the Anti-lock Braking System (ABS) control module. This can stem from intermittent wiring faults, poor grounding, or failure within the ABS ECU itself. Diagnosing the issue involves checking the ABS module's power and communication wiring and confirming the integrity of the associated connectors.

In Ford vehicles, U1900 indicates a CAN communication bus fault that often points to a generalized failure of communication between modules. Unlike more specific codes that identify a single module, this code suggests that the network as a whole may be compromised, potentially due to a bus overload, poor signal integrity, or a malfunctioning gateway module. Diagnosing this condition requires assessing the full CAN topology, checking wiring between modules, and potentially removing suspect ECUs from the network one at a time to isolate the issue.

U0127, used by Toyota, reflects lost communication with the Tire Pressure Monitoring System (TPMS) receiver module. The likely cause is a disconnected or improperly configured receiver or physical damage to the wiring. Technicians should verify the module's connection, confirm that the TPMS module is correctly programmed to the vehicle, and ensure that it has access to the CAN bus.

General Motors (GM) uses U1000 to indicate a Class 2 communication fault, a term used to describe its legacy low-speed data network. While the U1000 code does not point to a single module, it highlights a disruption in communication across the broader network. The diagnostic process involves verifying power and ground across all modules, checking CAN backbone wiring, and ensuring proper bus termination resistance.

U1300, also used by GM (and often seen in Chevrolet models), points specifically to a low signal condition in Class 2 communication, usually the result of a short to ground or open circuit. Water intrusion, connector corrosion, or abrasion of the wiring harness can cause this issue. Technicians are advised to examine the wiring for environmental damage, perform resistance checks, and reseal or replace affected connectors.

In certain Honda models, a variant of the common U0100 code may appear, which also indicates lost communication with the ECM/PCM but is handled differently in proprietary diagnostics. This may be due to a fault in ignition power delivery, a damaged communication path, or an issue internal to the module. Diagnosis should include voltage testing at the ECM, CAN bus integrity checks, and confirming ECU wake-up behavior.

Lastly, U1113 in Jeep vehicles denotes lost communication with the Fuel Pump Control Module. This code may appear if the module is disconnected, its communication lines are shorted, or the module has failed outright. Resolution steps include confirming power and ground delivery, checking for clean and secure CAN line connections, and replacing the module if found to be non-responsive despite healthy wiring.

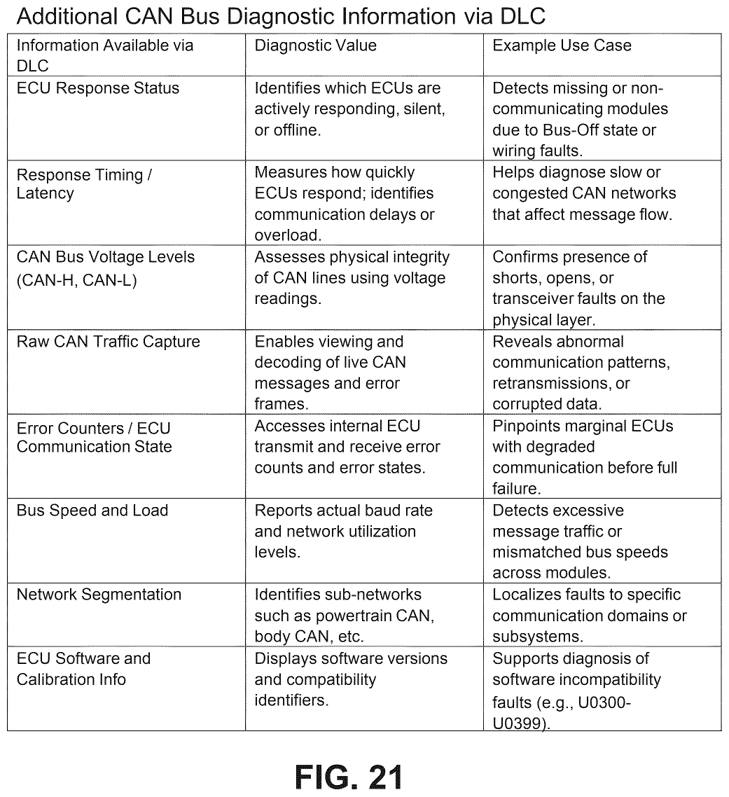

FIG. 21 is a table illustrating examples of additional CAN bus information that is obtainable from a DLC port, along with an associated diagnostic value and example use.

In addition to retrieving DTCs, the vehicle's DLC provides access to a wide range of information that can significantly assist in the analysis and resolution of CAN bus-related issues. When accessed through appropriate diagnostic tools, the DLC enables deeper insight into the operational state of the CAN and its associated modules beyond what is available from standard fault codes alone.

For example, diagnostic devices may interrogate the network to determine which ECUs are actively responding to polling requests. This enables technicians to identify modules that are unresponsive, offline, or exhibiting intermittent communication. Such behavior is often indicative of ECUs that have entered a “bus off” state due to excessive communication errors, or those that have become electrically isolated due to wiring faults.

Furthermore, many advanced diagnostic tools are capable of analyzing response latency and communication timing between ECUs. By evaluating how long each module takes to respond to a request or transmit its expected message, these tools can detect CAN network congestion, excessive bus load, or slow module response times, conditions that may not trigger DTCs but can degrade network performance and lead to intermittent faults.

In some cases, tools connected to the DLC can also measure the physical voltage levels on the CAN High and CAN Low lines. This measurement is critical for verifying the integrity of the CAN bus at the physical layer. Voltage readings that deviate from expected differential signaling thresholds (typically centered around 2.5 volts with a ±1V differential) may suggest the presence of wiring shorts, open circuits, or damaged CAN transceivers.

For in-depth analysis, certain diagnostic platforms may provide access to the raw CAN message traffic itself, capturing and decoding data frames in real time. This functionality allows for the identification of abnormal message patterns, repeated retransmissions, arbitration losses, and corrupted data frames, all of which are signs of instability or malfunction within the network.

Additionally, many ECUs internally maintain communication error counters, including transmit and receive error counts. When accessible through the DLC, these counters can help isolate marginal or failing ECUs that may still be present on the network but are experiencing degraded communication. Similarly, ECUs may report their current communication state, such as “error active,” “error passive,” or “bus off,” which further aids in fault triage.

Other useful network-level information may include the CAN bus speed (e.g., 500 kbps or 250 kbps), current network load (as a percentage of bandwidth utilization), and identification of separate communication domains such as powertrain CAN, body CAN, and infotainment CAN. These details assist in verifying whether a communication fault is isolated to a specific subsystem or spans multiple networks.

Finally, the DLC also allows access to standardized and proprietary information regarding ECU software versions and calibration identifiers (typically via Mode $09 or equivalent services). This information is particularly relevant when diagnosing software-related communication errors, such as those associated with software incompatibility (e.g., DTCs in the U0300-U0399 range).

Collectively, the ability to obtain this expanded set of diagnostic data from the DLC supports a more comprehensive and precise analysis of CAN bus health. The enhanced diagnostic processes described in the present disclosure may be configured to leverage one or more of these data types to detect communication faults, isolate root causes, and guide corrective action more effectively than conventional DTC-based approaches alone.

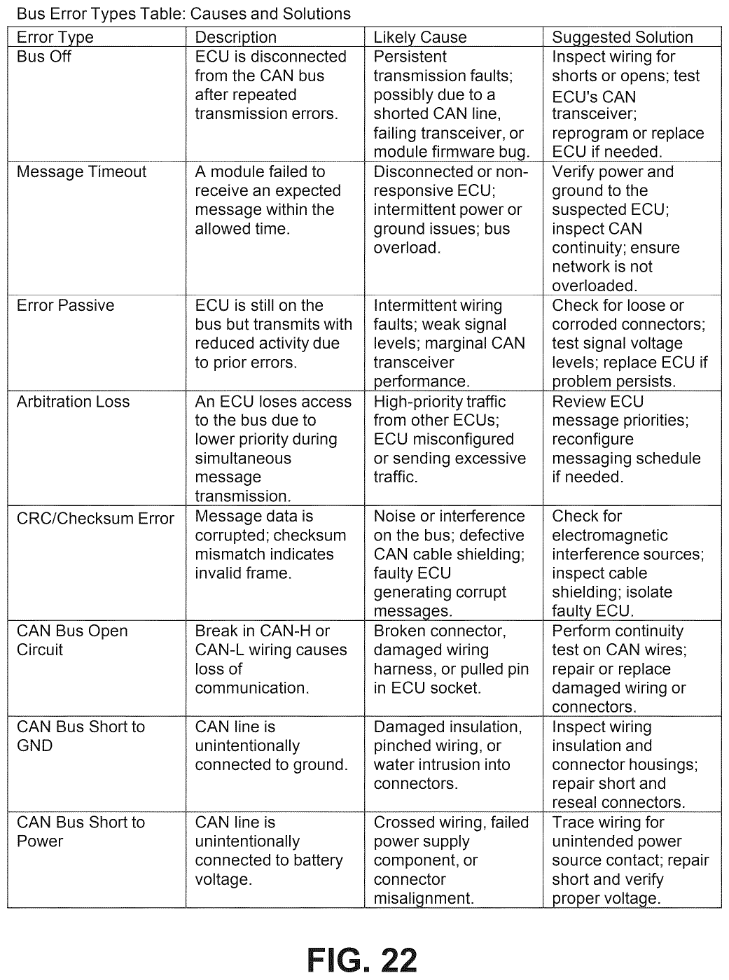

The information presented in FIG. 22 is derived from a combination of automotive industry standards, manufacturer diagnostic practices, and engineering-level technical documentation. These error types are not arbitrary, they stem from the core principles of how the CAN protocol operates in vehicles, as defined in the international ISO 11898 standard.

At the heart of the CAN system are built-in mechanisms for error detection, network arbitration, and self-recovery. Terms such as Bus Off, Error Passive, Arbitration Loss, and Checksum (CRC) Error are defined within the protocol itself. These represent specific states that an ECU can enter when communication faults occur. For instance, if an ECU consistently transmits faulty messages, it will eventually enter the “Bus Off” state, where it is automatically disconnected from the network to preserve overall system integrity. Similarly, if multiple ECUs attempt to transmit simultaneously, a controlled process known as arbitration ensures that only the highest-priority message proceeds, while others are delayed, if this process fails, it can result in arbitration loss.

Beyond protocol-defined faults, many of the listed errors also reflect physical-layer issues in the CAN wiring itself. These include open circuits, where a CAN wire is broken or disconnected, and shorts, where a CAN wire comes into unintended contact with ground or power. While the ISO standard outlines the logical framework of CAN behavior, the detection and classification of these physical faults are often expanded upon by automotive manufacturers (OEMs) in their service manuals and diagnostic routines. OEMs also provide interpretation layers, often implemented in dealer diagnostic tools, that translate raw CAN behavior into technician-friendly terms like “message timeout” or “lost communication.”

In practice, certain automotive scan tools and OEM-specific tools display these CAN errors in real time to guide technicians during troubleshooting. These tools rely on internal definitions, rooted in the CAN standard but tailored for practical use, that help technicians trace the source of communication faults quickly and accurately.

Additionally, detailed technical documentation from semiconductor manufacturers reinforce and explain these error states in engineering terms. These white papers and datasheets form the technical backbone of CAN diagnostics and describe how the hardware detects, categorizes, and responds to communication failures.

In summary, the CAN error types listed in the table reflect both core protocol behaviors and real-world diagnostic practices, merging formal standards with the language and tools technicians use every day to resolve network-related faults in vehicles.

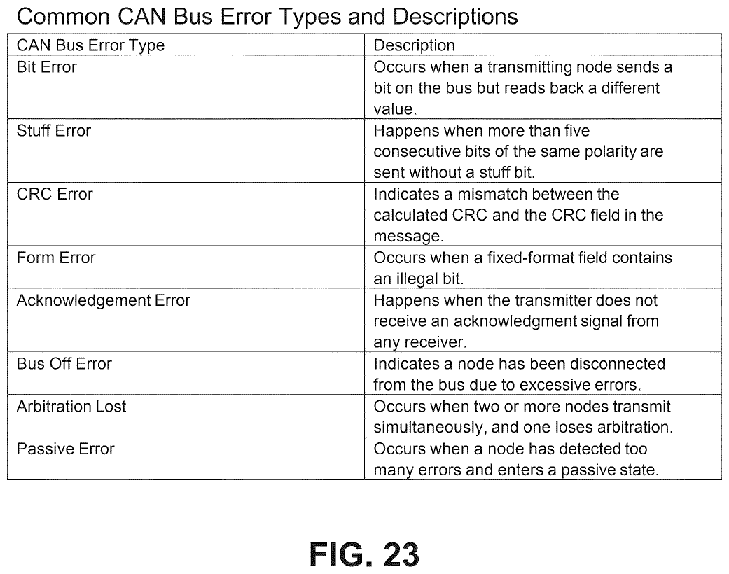

The table in FIG. 23 outlines examples of several key error conditions that may occur on a CAN and provides a technical interpretation of each condition, along with likely causes and recommended solutions. These error types reflect both logical protocol-level faults and physical-layer issues that can disrupt communication between ECUs within a vehicle.

The first error type listed is Bus Off, a critical condition in which an ECU is forced off the CAN network due to exceeding the maximum allowed transmission errors. This is often caused by persistent wiring faults, such as a shorted CAN line, or by a failing CAN transceiver inside the ECU. To resolve this, technicians are advised to inspect the network wiring for damage or shorts, test the transceiver circuitry, and consider replacing the affected module if necessary.

The second condition, Message Timeout, refers to a situation where a module fails to receive a message from another ECU within the expected time window. This typically results from a disconnected or powered-down ECU, an intermittent power or ground issue, or a bus that is overloaded with too many messages. Diagnosing this issue involves checking the target ECU's power supply, verifying wiring continuity, and ensuring that the network is not saturated with excessive traffic.

Error Passive is a fault state in which an ECU remains on the CAN network but transmits with reduced priority due to a history of communication errors. Common causes include weak signal levels, corroded connectors, or marginal transceiver performance. To address this, technicians should examine connector integrity, assess voltage levels, and replace the ECU if it repeatedly enters this state despite no external wiring faults.

The Arbitration Loss error occurs when two or more ECUs attempt to transmit at the same time, and one loses priority based on CAN arbitration rules. Although this is a normal part of CAN operation, repeated or improper arbitration loss may indicate an ECU is misconfigured or attempting to send too much data at the wrong time. In such cases, reprogramming the ECU to adjust message priority or scheduling may be required.

A CRC (Cyclic Redundancy Check) Error, also called a checksum error, indicates that the data within a CAN message was corrupted during transmission. This is frequently due to electrical noise, inadequate cable shielding, or a malfunctioning ECU. Diagnosing such issues requires checking for nearby sources of electromagnetic interference, inspecting the physical condition of CAN wiring, and isolating the module generating the invalid messages.

The CAN Bus Open Circuit condition represents a break in the communication line, which can prevent entire sections of the network from functioning. Causes typically include broken wires, damaged connectors, or improperly seated pins. A continuity test on the CAN lines and physical inspection of harnesses and connectors are essential to locating and repairing the fault.

CAN Bus Short to Ground describes a condition where either CAN-H or CAN-L is electrically connected to ground, usually as a result of damaged insulation, crushed wiring, or water ingress into connectors. Resolution involves visually inspecting the wire harness for physical damage and corrosion, repairing or replacing affected sections, and ensuring proper environmental sealing.

Finally, CAN Bus Short to Power occurs when one of the CAN lines is shorted to battery voltage or another power source. This can be caused by a wiring harness fault, connector misalignment, or an ECU failure. Identifying and correcting the fault involves tracing the wiring to the point of unintended contact, repairing the short, and confirming the voltage levels return to specification.

Collectively, these error types provide a comprehensive view of the common failure modes associated with CAN-based communication systems. Understanding their characteristics and how to resolve them allows technicians and diagnostic systems to quickly restore network functionality, ensure safe vehicle operation, and prevent cascading faults across interconnected control modules.

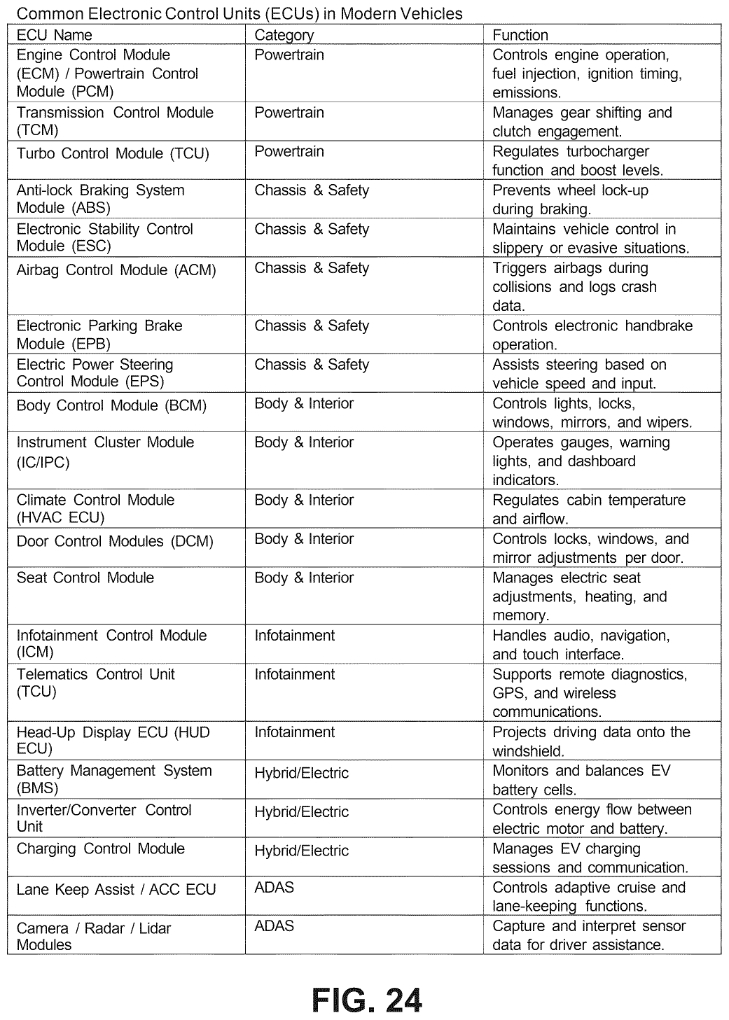

FIG. 24 shows a table of ECUs commonly found in vehicles today. These ECUs are typically categorized based on their domain, such as powertrain, chassis and safety, body and interior, infotainment, hybrid/electric systems, and advanced driver-assistance systems (ADAS). The table lists 21 of the most commonly implemented ECUs in these categories, including a brief summary of each unit's role within the vehicle.

In the powertrain category, for instance, the ECM or PCM is responsible for real-time management of engine performance and emissions, while the TCM controls gear shifting. These modules must frequently exchange information with one another and with other systems to coordinate functions like downshifting during hard braking or fuel cut-off during deceleration. This coordination is made possible via the CAN bus, which provides the digital communication backbone that interconnects all these modules.

Similarly, in the chassis and safety domain, ECUs like the ABS module, the ESC module, and Airbag Control Module (ACM) must respond quickly to changes in speed, yaw, or impact detection. They communicate frequently with the ECM, steering system, and wheel speed sensors. The CAN bus ensures that data from sensors and commands from modules can be exchanged quickly and reliably, which is essential for maintaining vehicle stability and occupant safety.

Body and interior ECUs, such as the Body Control Module (BCM), Door Control Modules, and Seat Control Module, manage features like lighting, door locking, window operation, and seat positioning. These systems rely on the CAN bus to interact with one another, for example, to lock all doors automatically when the vehicle reaches a certain speed, or to activate seat memory settings when a specific key fob is detected.

In the infotainment and connectivity sector, the Infotainment Control Module (ICM) and Telematics Control Unit (TCU) control user-facing features such as touchscreens, navigation, audio, and wireless communication. These modules often operate over a dedicated low-speed or multimedia CAN bus (or sometimes Ethernet in modern vehicles), but still rely on the main CAN backbone to pull in data like vehicle speed or reverse gear engagement for rear camera activation.

Hybrid and electric vehicles incorporate ECUs such as the Battery Management System (BMS), Inverter/Converter Control Unit, and Charging Control Module, which manage high-voltage battery health, energy conversion, and charge protocols. These units also use the CAN bus to report battery status to the cluster, regulate charging, and interface with powertrain controllers.

Finally, the ADAS category includes ECUs responsible for advanced features like lane-keeping, adaptive cruise control, and sensor fusion from cameras, radar, and lidar. These systems must interact with multiple other ECUs in real time to calculate driving paths, monitor surroundings, and take corrective actions. The CAN bus facilitates the rapid exchange of vehicle dynamics data, such as steering angle, speed, and brake status—needed for safe operation.

In summary, ECUs listed in the table communicate with one or more other ECUs through the CAN bus, forming an interconnected network of intelligent nodes. The CAN bus enables the modular design of vehicle systems, where each module can function autonomously yet collaborates seamlessly with others. This design reduces wiring complexity, improves reliability, and allows for fast and deterministic data exchange, making it the cornerstone of modern automotive control systems.

The systems and methods described herein are not directed to an abstract idea, mental process, or mathematical formula. Instead, they are directed to a concrete and practical technological solution: improving diagnostic precision and repair prioritization within a vehicle's CAN system. The method uses a specialized diagnostic device to automatically scan, filter, and organize DTCs in a way that is not feasible by a human technician unaided by the invention. Moreover, the invention improves the performance and usability of vehicle diagnostic systems by reducing diagnostic time, minimizing guesswork, and structuring repair workflows, thus representing a clear improvement to a technological process.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A diagnostic system configured to group and prioritize CAN-related faults across multiple ECUs based on shared fault conditions for controller area network (CAN) bus fault detection, comprising:
a processor;
a memory communicatively coupled to the processor;
a communication interface configured to communicate with a plurality of vehicle electronic control units (ECUs) via at least one CAN bus using a wireless or wired data connection to the vehicle's diagnostic system;
a user interface including a display;
wherein the processor is configured, in response to diagnostic trouble codes (DTCs) retrieved from the at least one CAN bus, to autonomously
identify a subset of the retrieved DTCs that are indicative of CAN bus communication faults by filtering out DTCs unrelated to CAN communications;
group the identified CAN-related DTCs from different ECUs into one or more fault groups, each fault group corresponding to a common CAN bus fault condition;
determine a repair priority for each fault group based on criteria including one or more of severity, fault integrity, or historical vehicle data; and
show on the display fault information for each fault group, including the grouped CAN-related DTCs and corresponding repair guidance.

2. The system of claim 1, wherein the communication interface is further configured to monitor CAN bus traffic in real time and detect anomalies indicative of communication degradation or node isolation.

3. The system of claim 1, wherein retrieving diagnostic trouble codes comprises polling each of the plurality of ECUs via the CAN bus using a standard diagnostic protocol to request stored DTCs and receiving the DTCs from each ECU in response.

4. The system of claim 1, wherein identifying the subset of DTCs indicative of CAN bus communication faults comprises
comparing retrieved DTCs to communication fault codes stored in memory and applicable to an associated vehicle type;
identifying a DTC as CAN-related if it corresponds to an error condition associated with bus-off status, signal timeout, message framing, or arbitration loss; and
excluding DTCs that are unrelated to network communication issues.

5. The system of claim 1, wherein grouping the identified CAN-related DTCs comprises:
generating a fault group when two or more ECUs reside on a shared CAN segment indicating a potential segment level communication fault.

6. The system of claim 1, wherein determining the repair priority for each fault group comprises evaluating at least one of: a number of ECUs affected by the fault, a severity level associated with the fault, or an impact on vehicle operation, and assigning a higher priority to fault groups indicating more widespread or severe communication failures.

7. The system of claim 1, wherein the memory further stores a local fault code database of known CAN bus communication fault codes and corresponding repair information, and wherein the processor is further configured to utilize the fault code database to generate the repair guidance displayed for each fault group.

8. A method of computer assisted grouping and prioritizing of CAN-related faults across multiple ECUs based on shared fault conditions for diagnosing and guiding repair of a vehicle communication network, the method comprising:
connecting a diagnostic device to a vehicle communication port;
automatically scanning a plurality of electronic control units (ECUs) via a Controller Area Network (CAN) bus to retrieve diagnostic trouble codes (DTCs);
filtering the retrieved DTCs to identify those associated with CAN bus communication faults; grouping DTCs that share identical definitions across multiple ECUs;
generating, based on DTC status and grouping, a prioritized list of CAN-related DTCs requiring repair;
displaying to a user, via a user interface, the prioritized DTCs along with one or more of associated definitions, affected systems, possible causes, and suggested repairs;
receiving user input confirming repair actions;
automatically re-scanning the CAN network to determine if faults are resolved; and
updating the display to reflect post-repair DTC status.

9. The method of claim 8, wherein the filtering step comprises matching DTC definitions to keywords including “communication”, “timeout”, “bus-off”, “invalid data”, or terms that are semantically or conceptually equivalent thereto.

10. The method of claim 8, wherein grouping comprises associating repeated DTCs with each reporting ECU and tagging the group as a systemic fault.

11. The method of claim 8, wherein prioritizing comprises applying a scoring algorithm that considers one or more of: the DTC status, number of affected ECUs, and system criticality.

12. The method of claim 8, further comprising retrieving updated DTC definitions and known fault conditions from a remote server.

13. The method of claim 8, wherein displaying the prioritized DTCs further comprises assigning a visual indicator to each DTC representing urgency level.

14. The method of claim 8, wherein user input includes marking DTCs as repaired or deferred, and such feedback is stored for historical tracking or adaptive learning.

15. A non-transitory computer-readable medium storing instructions that, when executed by at least one processor of a vehicle diagnostic device, cause the device to perform operations for grouping and prioritizing CAN-related faults across multiple ECUs based on shared fault conditions for CAN bus fault detection, the operations comprising:
obtaining, via a communication interface of the diagnostic device coupled to a vehicle's CAN bus, diagnostic trouble codes (DTCs) from a plurality of electronic control units (ECUs) in the vehicle;
filtering the obtained DTCs to identify those DTCs that indicate faults in CAN bus communication, while excluding DTCs unrelated to CAN bus issues;
consolidating the identified CAN bus-related DTCs from different ECUs into one or more groups, each group corresponding to a particular CAN bus fault condition affecting multiple components;
assigning a repair priority to each fault group based on predefined criteria that account for scope of impact or severity of the corresponding CAN bus fault; and
presenting, on a display of the diagnostic device, information for each fault group including the consolidated DTCs and a recommended repair action for addressing the CAN bus fault.

16. The non-transitory computer-readable medium of claim 15, wherein the instructions for obtaining the diagnostic trouble codes comprise instructions to automatically query each of the plurality of ECUs over the CAN bus using a diagnostic communication protocol and to collect the DTCs reported by each ECU in response.

17. The non-transitory computer-readable medium of claim 15, wherein the instructions for filtering the obtained DTCs include instructions to recognize diagnostic trouble codes associated with CAN communication errors and to disregard DTCs that pertain to non-CAN-related faults.

18. The non-transitory computer-readable medium of claim 15, wherein the instructions for consolidating the identified CAN bus-related DTCs include instructions to determine when multiple ECUs have recorded communication loss with a specific ECU or network segment and to merge such records into a single fault group corresponding to that communication loss.

19. The non-transitory computer-readable medium of claim 15, wherein the instructions for assigning the repair priority include instructions to rank the fault groups, or collection of fault groups, based on criteria including a number of ECUs reporting the fault and a severity classification of the fault or based on a comparison of freeze frame data or live data from an associated vehicle on-board diagnostic device.

20. The non-transitory computer-readable medium of claim 15, wherein the instructions for presenting the information include instructions to display for each fault group a descriptive fault summary and troubleshooting guidance derived from data stored locally on the device.
